(19) United States
(12) Patent Application Publication
(10) Pub. No.: US 2005/0166266 A1
(43) Pub. Date: Jul. 28, 2005

(54) Service providing system, application management system, service providing apparatus, service providing program, application management program, recording medium, service providing method, and application management method

(76) Inventors: Shinya Taniguchi, Suwa-shi (JP); Akihito Fukao, Chino-shi (JP)

Correspondence Address: HARNESS, DICKEY & PIERCE, P.L.C., P.O. BOX 828, BLOOMFIELD HILLS, MI, 48303, US

(21) Appl. No.: 11/044,901

(22) Filed: Jan. 27, 2005

(30) Foreign Application Priority Data
Jan. 28, 2004 (JP) 2004-019921
Sep. 17, 2004 (JP) 2004-270632

(51) Int. Cl. H04L 9/32

(52) U.S. Cl. 726/22; 713/187

(57) ABSTRACT

A service providing system is provided which can easily perform service management of devices. A device management terminal configures device groups based on group configuration information and device information, detects added, deleted, or changed devices from the configured device groups as target devices, and performs group operations to the detected target devices. Further, the device management terminal configures application groups based on the group configuration information and the application information, detects added, deleted, or changed applications from the configured application groups as target applications, and performs group operations relating to the detected target applications to the devices.

### RELATED APPLICATIONS

This application claims priority to Japanese Patent Application Nos. 2004-019921 filed Jan. 28, 2004 and 2004-270632 filed Sep. 17, 2004 which are hereby expressly incorporated by reference herein in their entirety.

### BACKGROUND

1. Technical Field

The present invention relates to a system, a program, and a method of providing a service to devices. More specifically, the present invention relates to a service providing system, an application management system, a service providing apparatus, a service providing program, an application management program, a recording medium, a service providing method, and an application management method which can easily perform service management of the devices.

2. Related Art

In recent years, into a device such as a cellular phone or a printer, an environment which executes an application is incorporated. For this reason, in such a device, there is a need for incorporating a new application or for deleting an unnecessary application in compliance with an update of the application. Up to now, the incorporation or removal of the application has been performed by a user or an administrator of the device. However, when the administrator performs the incorporation or deletion of the application, he can deal with only one device at a time. Thus, there is a problem in that an increase of the number of devices imposes a heavy burden on him. Accordingly, a technique in which a plurality of devices and an application distribution server are connected to each other via a network and the distribution of the application is performed by means of the application distribution server in a batch manner is developed.

Conventionally, as the application distribution server, for example, a network system disclosed in Japanese Unexamined Patent Application Publication No. 4-96159 and a version-up method of software disclosed in Japanese Unexamined Patent Application Publication No. 3-286345 are known.

The invention disclosed in Japanese Unexamined Patent Application Publication No. 4-96159 relates to the network system in which a plurality of workstations are connected to each other via a network. Further, the network system has a file server for storing software, a storing unit for storing at least information of names of the workstations which are installing destinations of the software, and an installing unit for referring the content in the storing unit whenever new software is stored in the file server and for automatically installing the software to the workstations to which the software is to be installed.

The invention disclosed in Japanese Unexamined Patent Application Publication No. 3-286345 relates to a network connecting a plurality of computers. The network has a software storing unit for storing version-up software which performs a version-up of software being used in each computer, a distribution destination storing unit for storing destinations to be distributed when the version-up of the software is performed, and a version-up management unit for detecting that the version-up is performed, searching destinations from the distribution destination storing unit, and distributing the version-up software stored in the software storing unit to the searched destinations.

As described above, in the inventions disclosed in Japanese Unexamined Patent Application Publication No. 4-96159 and Japanese Unexamined Patent Application Publication No. 3-286345, the administrator creates a list of the devices which are targets of application distribution, and then the application is distributed to the devices in a batch manner with reference to the device list. Accordingly, even if the number of devices increases, it dose not impose a heavy burden on the administrator.

However, when the number of devices increases or decreases, or when attributes or the like of the devices change, new applications are to be distributed to added or changed devices, among the devices or necessary applications are to be deleted from added or changed devices among the devices. Further, when the number of applications which are distributed to a specified device (for example, a partial range of devices) increases or decreases, or when attributes of the applications which are distributed to the specified device change, added or changed applications are to be distributed to the specified device and unnecessary applications are to be deleted from the specified device. In the invention of Japanese Unexamined Patent Application Publication No. 4-96159 and Japanese Unexamined Patent Application Publication No. 3-286345, the distribution of the application is performed in a batch manner, but the device list is to be created every time. Thus, there is a problem in that the application management of the device is complex.

Such a problem is not limited to the case in which the application is distributed to a plurality of devices. For example, it can be assumed that the same problem is caused in the case in which services other than the application distribution service are provided to the plurality of devices.

Accordingly, the present invention is made in consideration of the unsettled problems in the conventional art, and it is an object of the present invention to provide a service providing system, an application management system, a service providing apparatus, a service providing program, an application management program, a recording medium, a service providing method, and an application management method which can easily perform service management of the devices.

### SUMMARY

In order to achieve the above-mentioned object, there is provided a service providing system of a first aspect, in which a plurality of devices are communicably connected to each other and which provides a service to at least one device of the plurality of communicably connected devices. The service providing system comprises a device information storing unit for storing device information which indicates attributes of the communicably connected devices, a group configuration information storing unit for storing group configuration information which includes conditions of devices constituting device groups, a device group configuration unit for configuring the device groups based on the group configuration information in the group configuration information storing unit and the device information in the device information storing unit, a target device detecting unit for detecting added, deleted, or changed devices from the device groups configured by the device group configuration unit as target devices, and a service providing unit for providing the service to the target devices detected by the target device detecting unit.

As such, the device groups are configured by the device group configuration unit based on the group configuration information in the group configuration information storing unit and the device information in the device information storing unit. Then, the added, deleted, or changed devices are detected from the configured device groups as the target devices by the target device detecting unit, and the service is provided to the detected target devices by the service providing unit.

Thus, when the number of devices increases or decreases, or when attributes of the devices change, the device information in the device information storing unit may be registered, deleted or changed, or the group configuration information in the group configuration information storing unit may change, such that the configurations of the groups may change. Accordingly, the service is provided to the added, deleted, or changed devices (the target devices) among the plurality of devices. Therefore, by changing the device information, the group configuration information, the service can be provided to the target devices. As a result, as compared to the conventional art, the invention has the advantage that the service management of the devices can be performed relatively easily.

Here, the provision of the service includes, for example, performing the distribution or deletion of the application, providing data such as web pages, mail or the like, permitting or prohibiting uses of network resources (for example, hardware resources or software resources of devices or other terminals), permitting or prohibiting uses of network services (for example, usable services via the network, such as online banking services) and instructing the provisions of the services (for example, requesting terminals executing the provisions of the services as a proxy for the provisions of the services) are included. These are only exemplifications to the last, but the provisions of the services may be performed separately from each other or may be complexly performed through the combination of two or more services. Hereinafter, the same is applied to a service providing system of a second aspect, service providing apparatuses of seventeenth and eighteenth aspects, service providing programs of nineteenth and twentieth aspects, recording mediums of thirty-fifth and thirty-sixth aspects, and service providing methods of thirty-ninth and fortieth aspects.

Further, the device means an apparatus which receives the provision of the service to operate. Hereinafter, the same is applied to the service providing system of the second aspect, the service providing apparatus of the seventeenth or eighteenth aspect, the service providing program of the nineteenth or twentieth aspect, the recording medium of the thirty-fifth or thirty-sixth aspect, and the service providing method of the thirty-ninth or fortieth aspect.

Further, the device information storing unit is a device which stores the device information by using various means at all times. In addition, as the device information storing unit, a device which pre-stores the device information may be used or a device which stores the device information by an input from an exterior or the like at the time of the operation of the present system, without previously storing the device information, may be used. Hereinafter, the same is applied to an application management system of a third aspect.

Further, the group configuration information storing unit is a device which stores the group configuration information by using various means at all times. In addition, as the group configuration information storing unit, a device which pre-stores the group configuration information may be used or a device which stores the group configuration information by an input from an exterior at the time of the operation of the present system, without previously storing the group configuration information, may be used. Hereinafter, the same is applied to the service providing system of the second aspect and the application management systems of the third and sixteenth aspects.

Further, the present system may be realized as a single apparatus, a single terminal or other apparatus or may be realized as a network system in which a plurality of devices, terminals or other apparatuses are communicably connected. In the latter, the respective elements may belong to any one of the plurality of apparatuses or the like if they are communicably connected to each other. Hereinafter, the same is applied to the service providing system of the second aspect and the application management systems of the third and sixteenth aspects.

In addition, there is provided a service providing system of the second aspect, in which devices are communicably connected to each other and which provides any one of a plurality of services to the communicably connected devices. The service providing system comprises a service information storing unit for storing service information which indicates attributes of the services for every service, a group configuration information storing unit for storing group configuration information which includes conditions of services constituting service groups, a service group configuration unit for configuring the service groups based on the group configuration information in the group configuration information storing unit and the service information in the service information storing unit, a target service detecting unit for detecting added, deleted, or changed services from the service groups configured by the service group configuration unit as target services, and a service providing unit for providing the target services detected by the target service detecting unit to the devices.

As such, the service groups are configured by the service group configuration unit based on the group configuration information in the group configuration information storing unit and the service information in the service information storing unit. Then, the added, deleted, or changed services are detected from the configured service groups as the target services by the target service detecting unit, and the detected target services are provided to the devices by the service providing unit.

Thus, when the number of services increases or decreases, or when attributes of the services change, the service information in the service information storing unit may be registered, deleted or changed, or the group configuration information in the group configuration information storing unit may change, such that the configurations of the groups may change. Accordingly, the added, deleted, or changed services (the target services) among the plurality of services are provided to the devices. Therefore, by changing the service information and the group configuration information, the target services can be provided to the devices. As a result, as compared to the conventional art, the invention has the advantage that the service management of the devices can be performed relatively easily.

Here, when the distribution or deletion of the application is performed, the provision of any one of the plurality of services includes, for example, distributing or deleting any one of a plurality of applications to or from the devices. Further, when the provision of data such as web pages, mail or the like is performed, any one of a plurality of data may be provided. In addition, when the uses of a plurality of network resources are permitted or prohibited, the use of any one of the plurality of network resources may be permitted or prohibited. Also, when the uses of a plurality of the network services are permitted or prohibited, the use of any one of the plurality of network services may be permitted or prohibited. Hereinafter, the same is applied to the service providing apparatus of the eighteenth aspect, the service providing program of the twentieth aspect, the recording medium of the thirty-sixth aspect, and the service providing method of the fortieth aspect.

Further, the service information storing unit is a device which stores the service information by using various means at all times. In addition, as the service information storing unit, a device which pre-stores the service information may be used or a device which stores the service information by an input from an exterior or the like at the time of the operation of the present system, without previously storing the service information, may be used.

Meanwhile, in order to achieve the above-mentioned object, there is provided an application management system of a third aspect, in which a plurality of devices are communicably connected to each other and which manages applications of the plurality of communicably connected devices. The service providing system comprises a device information storing unit for storing device information which indicates attributes of the communicably connected devices, a group configuration information storing unit for storing group configuration information which includes conditions of devices constituting device groups, a device group configuration unit for configuring the device groups based on the group configuration information in the group configuration information storing unit and the device information in the device information storing unit, a target device detecting unit for detecting added, deleted, or changed devices from the device groups configured by the device group configuration unit as target devices, and a group operation executing unit for performing group operations regarding distribution or deletion of the applications to the target devices detected by the target service detecting unit.

As such, the device groups are configured by the device group configuration unit based on the group configuration information in the group configuration information storing unit and the device information in the device information storing unit. Then, the added, deleted, or changed devices are detected from the configured device groups as the target devices by the target device detecting unit, and the group operations are performed on the detected target services by the group operation executing unit.

Thus, when the number of devices increases or decreases, or when attributes of the devices change, the device information in the device information storing unit may be registered, deleted or changed, or the group configuration information in the group configuration information storing unit may change, such that the configurations of the groups may change. Accordingly, the group operations are performed on the added, deleted, or changed devices (the target devices) of the plurality of devices. Therefore, by changing the device information and the group configuration information, the group operations can be performed on the target devices. As a result, as compared to the conventional art, the invention has the advantage that the application management of the devices can be performed relatively easily.

Here, the group operations mean operations regarding the distribution or deletion of the application. As the operations regarding the distribution of the application, for example, distributing the applications to the devices, transmitting an application distribution request to an application distribution terminal which executes the distribution of the application as a proxy, and creating an application distribution list in which the distribution destinations of the application are registered in association, with the application information to be distributed are included. Further, as the operations regarding the deletion of the application, for example, transmitting an application deletion command to the device, transmitting an application deletion request to an application deletion terminal which executes the deletion of the application as a proxy, and creating an application deletion list in which the deletion destinations of the application are registered in association with the application information to be deleted are included. Hereinafter, the same is applied to an application management system of a sixteenth aspect, an application management program of a twenty-first or thirty-fourth aspect, a recording medium of a thirty-seventh or thirty-eighth aspect, and an application management method of a forty-first or a fifty-fourth aspect.

Further, the device means an apparatus which can execute the application. Hereinafter, the same is applied to the application management system of the sixteenth aspect, the application management program of the twenty-first or thirty-fourth aspect, the recording medium of the thirty-seventh or thirty-eighth aspect, and the application management method of the forty-first or a fifty-fourth aspect.

In addition, in an application management system of a fourth aspect according to the third aspect, the group configuration information includes conditions of applications constituting application groups. Further, the application management system further comprises an application information storing unit for storing application information which indicates attributes of the applications for every application, an application group configuration unit for configuring the application groups based on the group configuration information in the group configuration information storing unit and the application information in the application information storing unit, and a group related information storing unit for storing group related information which indicates a correspondence relationship between the device groups and the application groups. In addition, the group operation executing unit is made to specify the application groups corresponding to the device groups to which the target devices belong, based on the group related information in the group related information storing unit, and perform the group operations relating to the applications, which belong to the specified application groups, to the target devices.

As such, the application groups are configured by the application group configuration unit based on the group configuration information in the group configuration information storing unit and the application information in the application information storing unit. Further, the application groups corresponding to the device groups to which the target devices belong are specified by the group operation executing unit based on the group related information in the group related information storing unit and the group operations relating to the applications which belong to the specified application groups are performed on the target devices.

Thus, by defining the correspondence relationship between the device groups and the application groups, the contents of the group operations to the devices can be set. Therefore, the invention has the advantage that the application management of the devices can be performed further easily.

Here, the application information storing unit is a device which stores the application information by using various means at all times. In addition, as the application information storing unit, a device which pre-stores the application information may be used or a device which stores the application information by an input from an exterior or the like at the time of the operation of the present system, without previously storing the application information, may be used. Hereinafter, the same is applied to the application management system of the sixteenth aspect.

Further, the group related information storing unit is a device which stores the group related information by using various means at all times. In addition, as the group related information storing unit, a device which pre-stores the group related information may be used or a device which stores the group related information by an input from an exterior or the like at the time of the operation of the present system, without previously storing the group related information, may be used.

In addition, an application management system of a fifth aspect according to the fourth aspect further comprises a target application detecting unit for detecting added, deleted, or changed applications from the application groups configured by the application group configuration unit as target applications. Further, the group operation executing unit is made to specify the device groups corresponding to the application groups to which the target applications detected by the target application detecting unit belong, based on the group related information in the group related information storing unit, and perform the group operations relating to the target applications to the devices which belong to the specified device groups.

As such, the added, deleted, or changed applications are detected from the configured application groups as the target applications by the target application detecting unit. Then, the device groups corresponding to the application groups to which the detected target applications belong are specified by the group operation executing unit based on the group related information in the group related information storing unit and the group operations relating to the target applications are performed on the devices which belong to the specified device groups.

Thus, when the number of applications increases or decreases, or when attributes of the applications change, the application information in the application information storing unit may be registered, deleted or changed, or the group configuration information in the group configuration information storing unit may change, such that the configurations of the groups may change. Accordingly, the group operations relating to the added, deleted, or changed applications (the target applications) among the plurality of applications are performed on the devices. Therefore, by changing the application information and the group configuration information, the group operations relating to the target applications can be performed on the devices. As a result, as compared to the conventional art, the invention has the advantage that the application management of the devices can be performed relatively easily.

Here, the application storing unit is a device which stores the applications by using various means at all times. In addition, as the application storing unit, a device which pre-stores the applications may be used or a device which stores the applications by an input from an exterior or the like at the time of the operation of the present system, without previously storing the applications, may be used.

An application management system of a sixth aspect according to any one of the third to fifth aspects further comprises an application storing unit for storing applications. Further, the group operation executing unit is made to distribute the applications in the application storing unit to target devices to which the applications are to be added or of which applications are to be changed.

As such, the applications in the application storing unit are distributed to the target devices, to which the applications are to be added or of which applications are to be changed, by the group operation executing unit.

Thus, when the device is to be newly managed by the system or when the attributes or the like of the device change, suitable applications can be distributed to the devices. Therefore, the invention has the advantage that the distribution of the application can be performed suitably.

In an application management system of a seventh aspect according to any one of the third to sixth aspects, the group operation executing unit transmits an application deletion command to the target devices of which applications are to be deleted or changed.

As such, the application deletion command is transmitted to the target devices, of which applications are to be deleted or changed, by the group operation executing unit.

Thus, when the device is not to be managed by the system or when the attributes or the like of the device change, a suitable application deletion command can be received by the device. Therefore, the invention has the advantage that the deletion of the application can be performed suitably.

In an application management system of an eighth aspect according to any one of the third to seventh aspects, the detection by the target device detecting unit and the execution by the group operation executing unit are performed when a registration, deletion, or change of the device information is performed on the device information storing unit.

As such, the detection by the target device detecting unit and the execution by the group operation executing unit are performed at the time that the registration, deletion, or change of the device information is performed on the device information storing unit.

Thus, when the registration, deletion, or change of the device information is performed on the device information storing unit, the distribution or deletion of the application can be performed on the devices, of which application is to be changed, almost in real time. Therefore, the invention has the advantage that the immediate reactivity of the system can be improved.

In an application management system of a ninth aspect according to any one of the third to eighth aspects, the detection by the target device detecting unit and the execution by the group operation executing unit are performed when a change of the group configuration information is performed on the group configuration information storing unit.

As such, the detection by the target device detecting unit and the execution by the group operation executing unit are performed at the time that the change of the group configuration information is performed on the group configuration information storing unit.

Thus, when the change of the group configuration information is performed on the group configuration information storing unit, the distribution or deletion of the application can be performed on the devices, of which application is to be changed, almost in real time. Therefore, the invention has the advantage that the immediate reactivity of the system can be improved.

In an application management system of a tenth aspect according to any one of the third to ninth aspects, the detection by the target device detecting unit and the execution by the group operation executing unit are performed at predetermined intervals.

As such, the detection by the target device detecting unit and the execution by the group operation executing unit are performed at the predetermined intervals.

Thus, when the number of devices increases or decreases or when the attributes or the like of the devices frequently change, the invention has the advantage that the burden of the system can be prevented from drastically increasing.

In an application management system of an eleventh aspect according to any one of the third to tenth aspects, the detection by the target device detecting unit and the execution by the group operation executing unit are performed when an execution request is input.

As such, when the administrator inputs the execution request, the detection by the target device detecting unit and the execution by the group operation executing unit are performed at the administrator's timing.

Thus, the distribution or deletion of the application can be performed by the administrator's intention. Therefore, it has advantages that the administrator can easily understand and the application management of the devices can be further easily performed.

In an application management system of a twelfth aspect according to any one of the fifth to seventh aspects, the detection by the target application detecting unit and the execution by the group operation executing unit are performed when the registration, deletion, or change of the application information is performed on the application information storing unit.

As such, the detection by the target application detecting unit and the execution by the group operation executing unit are performed at the time that the registration, deletion, or change of the application information is performed on the application information storing unit.

Thus, when the registration, deletion, or change of the application information is performed on the application information storing unit, the distribution or deletion of the application relating the change or the like can be performed almost in real time. Therefore, the invention has the advantage that the immediate reactivity of the system can be improved.

In an application management system of a thirteenth aspect according to any one of the fifth to seventh and twelfth aspects, the detection by the target application detecting unit and the execution by the group operation executing unit are performed when the change of the group configuration information is performed on the group configuration information storing unit.

As such, the detection by the target application detecting unit and the execution by the group operation executing unit are performed at the time that the change of the group configuration information is performed on the group configuration information storing unit.

Thus, when the change of the group configuration information is performed on the group configuration information storing unit, the distribution or deletion of the application relating to the change or the like can be performed almost in real time. Therefore, the invention has the advantage that the immediate reactivity of the system can be improved.

In an application management system of a fourteenth aspect according to any one of the fifth to seventh, twelfth and thirteenth aspects, the detection by the target application detecting unit and the execution by the group operation executing unit are performed at predetermined intervals.

As such, the detection by the target application detecting unit and the execution by the group operation executing unit are performed at the predetermined intervals.

Thus, when the number of applications frequently increases or decreases or when the attributes or the like of the applications change frequently, the invention has the advantage that the burden of the system can be prevented from drastically increasing.

In an application management system of a fifteenth aspect according to any one of the fifth to seventh, and twelfth to fourteenth aspects, the detection by the target application detecting unit and the execution by the group operation executing unit are performed when an execution request is input.

As such, when an administrator inputs an execution request, the detection by the target application detecting unit and the execution by the group operation executing unit are performed at the time that the execution request is input.

Therefore, since the distribution or deletion of the application can be performed according to the administrator's intention, it has advantages that the management of the application of the device can be easily performed and can be easily understood by the administrator.

There is provided an application management system of a sixteenth aspect, in which devices are communicably connected to each other and which manages applications of the communicably connected devices. The application management system comprises an application information storing unit for storing application information which indicates attributes of the applications for every application, a group configuration information storing unit for storing group configuration information which includes conditions of applications constituting application groups, an application group configuration unit for configuring the application groups based on the group configuration information in the group configuration information storing unit and the application information in the application information storing unit, a target application detecting unit for detecting added, deleted, or changed applications from the application groups configured by the application group configuration unit as target applications, and a group operation executing unit for performing group operations regarding distribution or deletion of the target applications detected by the target application detecting unit to the devices.

As such, the application groups are configured by the application group configuration unit based on the group configuration information in the group configuration information storing unit and the application information in the application information storing unit. Then, the added, deleted, or changed applications are detected from the configured application groups as the target applications by the target application detecting unit and the group operations relating to the detected target applications are performed on the device by the group operation executing unit.

Thus, when the number of applications increases or decreases, or when attributes of the applications change, the application information in the application information storing unit may be registered, deleted or changed, or the group configuration information in the group configuration information storing unit may change, such that the configurations of the groups may change. Accordingly, the group operations relating to the added, deleted, or changed applications (the target applications) among the plurality of applications are performed on the devices. Therefore, by changing the application information or the group configuration information, the group operations relating to the target application can be performed on the devices. As a result, as compared to the conventional art, the invention has the advantage that the application management of the devices can be performed relatively easily.

Meanwhile, in order to achieve the above-mentioned object, there is provided a service providing apparatus of a seventeenth aspect, in which a plurality of devices are communicably connected to each other and which provides a service to at least one device of the plurality of communicably connected devices. The service providing apparatus comprises a device group configuration unit for acquiring from a database device, which has a device information storing unit for storing device information which indicates attributes of the communicably connected devices and a group configuration information storing unit for storing group configuration information which includes conditions of devices constituting device groups, the group configuration information and the device information, and for configuring the device groups based on the acquired group configuration information and device information, a target device detecting unit for detecting added, deleted, or changed devices from the device groups configured by the device group configuration unit as target devices, and a service providing unit for providing the service to the target devices detected by the target device detecting unit.

As such, the same operations and advantages as those in the service providing system of the first aspect are obtained.

Further, there is provided a service providing apparatus of an eighteenth aspect, in which devices are communicably connected to each other and which provides any one of a plurality of services to the communicably connected devices. The service providing apparatus comprises a service group configuration unit for acquiring from a database device, which has a service information storing unit for storing service information which indicates attributes of the services for every service and a group configuration information storing unit for storing group configuration information which includes conditions of services constituting service groups, the group configuration information and the service information, and for configuring the service groups based on the acquired group configuration information and the service information, a target service detecting unit for detecting added, deleted, or changed services from the service groups configured by the service group configuration unit as target services, and a service providing unit for providing the target services detected by the target service detecting unit to the devices.

As such, the same operations and advantages as those in the service providing system of the second aspect are obtained.

Meanwhile, in order to achieve the above-mentioned object, there is provided a service providing program of a nineteenth aspect, which provides a service to devices. The service providing program causes a computer, which uses a device information storing unit for storing device information which indicates attributes of the communicably connected devices and a group configuration information storing unit for storing group configuration information which includes conditions of devices constituting device groups, to execute a process. Further, the process comprises a device group configuration step of configuring the device groups based on the group configuration information in the group configuration information storing unit and the device information in the device information storing unit, a target device detection step of detecting added, deleted, or changed devices from the device groups configured in the device group configuration step as target devices, and a service provision step of providing the service to the target devices detected in the target device detection step.

As such, the computer reads the program and executes the process according to the program read. Thus, the same operations and advantages as those in the service providing system of the first aspect are obtained.

In addition, there is provided a service providing program of a twentieth aspect, which provides services to devices. The service providing program causes a computer, which uses a service information storing unit for storing service information which indicates attributes of the services for every service and a group configuration information storing unit for storing group configuration information which includes conditions of services constituting service groups, to execute a process. Further, the process comprises a service group configuration step of configuring the service groups based on the group configuration information in the group configuration information storing unit and the service information in the service information storing unit, a target service detection step of detecting added, deleted, or changed services from the service groups configured in the service group configuration step as target services, and a service provision step of providing the target services detected in the target service detection step to the devices.

As such, the computer reads the program and executes the process according to the program read. Thus, the same operations and advantages as those in the service providing system of the second aspect are obtained.

Meanwhile, in order to achieve the above-mentioned object, there is provided an application management program of a twenty-first aspect, which manages applications of devices. The application management program causes a computer, which uses a device information storing unit for storing device information which indicates attributes of the communicably connected devices and a group configuration information storing unit for storing group configuration information which includes conditions of devices constituting device groups, to execute a process. Further, the process comprises a device group configuration step of configuring the device groups based on the group configuration information in the group configuration information storing unit and the device information in the device information storing unit, a target device detection step of detecting added, deleted, or changed devices from the device groups configured in the device group configuration step as target devices, and a group operation execution step of performing group operations regarding distribution or deletion of the applications to the target devices detected in the target device detection step.

As such, the computer reads the program and executes the process according to the program read. Thus, the same operations and advantages as those in the application management system of the third aspect are obtained.

In addition, in an application management program of a twenty-second aspect according to the twenty-first aspect, the group configuration information includes conditions of applications constituting application groups. The computer is made to further use an application information storing unit for storing application information which indicates attributes of the applications for every application and a group related information storing unit for storing group related information which indicates a correspondence relationship between the device groups and the application groups. Further, the application management program causes the computer further to execute an application group configuration step of configuring the application groups based on the group configuration information in the group configuration information storing unit and the application information in the application information storing unit. In addition, in the group operation execution step, the application groups corresponding to the device groups to which the target devices belong are specified based on the group related information in the group related information storing unit and the group operations relating to the applications which belong to the specified application groups are performed on the target devices.

As such, the computer reads the program and executes the process according to the program read. Thus, the same operations and advantages as those in the application management system of the fourth aspect are obtained.

In addition, an application management program of a twenty-third aspect according to the twenty-second aspect causes the computer further to execute a target application detection step of detecting added, deleted, or changed applications from the application groups configured in the application group configuration step as target applications. Further, in the group operation execution step, the device groups corresponding to the application groups to which the target applications detected by the target application detecting unit belong are specified based on the group related information in the group related information storing unit and the group operations relating to the target applications are performed on the devices which belong to the specified device groups.

As such, the computer reads the program and executes the process according to the program read. Thus, the same operations and advantages as those in the application management system of the fifth aspect are obtained.

In an application management program of a twenty-fourth aspect according to any one of the twenty-first to twenty-third aspects, the computer is made to further use an application storing unit for storing applications. Further, in the group operation execution step, the applications in the application storing unit are distributed to target devices, to which the applications are to be added or of which applications are to be changed.

As such, the computer reads the program and executes the process according to the program read. Thus, the same operations and advantages as those in the application management system of the sixth aspect are obtained.

In an application management program of a twenty-fifth aspect according to any one of the twenty-first to twenty-fourth aspects, in the group operation execution step, an application deletion command is transmitted to the target devices, of which applications are to be deleted or changed.

As such, the computer reads the program and executes the process according to the program read. Thus, the same operations and advantages as those in the application management system of the seventh aspect are obtained.

In an application management program of a twenty-sixth aspect according to any one of the twenty-first to twenty-fifth aspects, the detection by the target device detection step and the execution by the group operation execution step are performed when a registration, deletion, or change of the device information is performed on the device information storing unit.

As such, the computer reads the program and executes the process according to the program read. Thus, the same operations and advantages as those in the application management system of the eighth aspect are obtained.

In an application management program of a twenty-seventh aspect according to any one of the twenty-first to twenty-sixth aspects, the detection by the target device detection step and the execution by the group operation execution step are performed when a change of the group configuration information is performed on the group configuration information storing unit.

As such, the computer reads the program and executes the process according to the program read. Thus, the same operations and advantages as those in the application management system of the ninth aspect are obtained.

In an application management program of a twenty-eighth aspect according to any one of the twenty-first to twenty-seventh aspects, the detection by the target device detection step and the execution by the group operation execution step are performed at predetermined intervals.

As such, the computer reads the program and executes the process according to the program read. Thus, the same operations and advantages as those in the application management system of the tenth aspect are obtained.

In an application management program of a twenty-ninth aspect according to any one of the twenty-first to twenty-eighth aspects, the detection by the target device detection step and the execution by the group operation execution step are performed when an execution request is input.

As such, the computer reads the program and executes the process according to the program read. Thus, the same operations and advantages as those in the application management system of the eleventh aspect are obtained.

In an application management program of a thirtieth aspect according to any one of the twenty-third to twenty-fifth aspects, the detection by the target application detection step and the execution by the group operation execution step are performed when the registration, deletion, or change of the application information is performed on the application information storing unit.

As such, the computer reads the program and executes the process according to the program read. Thus, the same operations and advantages as those in the application management system of the twelfth aspect are obtained.

In an application management program of a thirty-first aspect according to any one of the twenty-third to twenty-fifth and thirtieth aspects, the detection by the target application detection step and the execution by the group operation execution step are performed when the change of the group configuration information is performed on the group configuration information storing unit.

As such, the computer reads the program and executes the process according to the program read. Thus, the same operations and advantages as those in the application management system of the thirteenth aspect are obtained.

In an application management program of a thirty-second aspect according to any one of the twenty-third to twenty-fifth, thirtieth and thirty-first aspects, the detection by the target application detection step and the execution by the group operation execution step are performed at predetermined intervals.

As such, the computer reads the program and executes the process according to the program read. Thus, the same operations and advantages as those in the application management system of the fourteenth aspect are obtained.

In an application management program of a thirty-third aspect according to any one of the twenty-third to twenty-fifth, and thirtieth to thirty-second aspects, the detection by the target application detection step and the execution by the group operation execution step are performed when an execution request is input.

As such, the computer reads the program and executes the process according to the program read. Thus, the same operations and advantages as those in the application management system of the fifteenth aspect are obtained.

In addition, there is provided an application management program of a thirty-fourth aspect, which manages applications of devices. The application management program causes a computer, which uses an application information storing unit for storing application information which indicates attributes of the applications for every application and a group configuration information storing unit for storing group configuration information which includes conditions of applications constituting application groups, to execute a process. Further, the process comprises an application group configuration step of configuring the application groups based on the group configuration information in the group configuration information storing unit and the application information in the application information storing unit, a target application detection step of detecting added, deleted, or changed applications from the application groups configured in the application group configuration step as target applications, and a group operation execution step of performing group operations regarding distribution or deletion of the target applications detected in the target application detection step to the devices.

As such, the computer reads the program and executes the process according to the program read. Thus, the same operations and advantages as those in the application management system of the sixteenth aspect are obtained.

Meanwhile, in order to achieve the above-mentioned object, there is provided a recording medium of a thirty-fifth aspect, on which a service providing program for providing a service to devices is recorded. The service providing program causes a computer, which uses a device information storing unit for storing device information which indicates attributes of the communicably connected devices and a group configuration information storing unit for storing group configuration information which includes conditions of devices constituting device groups, to execute a process. Further, the process comprises a device group configuration step of configuring the device groups based on the group configuration information in the group configuration information storing unit and the device information in the device information storing unit, a target device detection step of detecting added, deleted, or changed devices from the device groups configured in the device group configuration step as target devices, and a service provision step of providing the service to the target devices detected in the target device detection step.

As such, the computer reads the program from the recording medium and executes the process according to the program read. Thus, the same operations and advantages as those in the service providing system of the first aspect are obtained.

In addition, there is provided a recording medium of a thirty-sixth aspect, on which a service providing program for providing services to devices is recorded. The service providing program causes a computer, which uses a service information storing unit for storing service information which indicates attributes of the services for every service and a group configuration information storing unit for storing group configuration information which includes conditions of services constituting service groups, to execute a process. Further, the process comprises a service group configuration step of configuring the service groups based on the group configuration information in the group configuration information storing unit and the service information in the service information storing unit, a target service detection step of detecting added, deleted, or changed services from the service groups configured in the service group configuration step as target services, and a service provision step of providing the target services detected in the target service detection step to the devices.

As such, the computer reads the program from the recording medium and executes the process according to the program read. Thus, the same operations and advantages as those in the service providing system of the second aspect are obtained.

In addition, there is provided a recording medium of a thirty-seventh aspect, on which an application management program for managing applications of devices is recorded. The application management program causes a computer, which uses a device information storing unit for storing device information which indicates attributes of the communicably connected devices and a group configuration information storing unit for storing group configuration information which includes conditions of devices constituting device groups, to execute a process. The process comprises a device group configuration step of configuring the device groups based on the group configuration information in the group configuration information storing unit and the device information in the device information storing unit, a target device detection step of detecting added, deleted, or changed devices from the device groups configured in the device group configuration step as target devices, and a group operation execution step of performing group operations regarding distribution or deletion of the applications to the target devices detected in the target device detection step.

As such, the computer reads the program from the recording medium and executes the process according to the program read. Thus, the same operations and advantages as those in the application management system of the third aspect are obtained.

In addition, there is provided a recording medium of a thirty-eighth aspect, on which an application management program for managing applications of devices is recorded. The application management program causes a computer, which uses an application information storing unit for storing application information which indicates attributes of the applications for every application and a group configuration information storing unit for storing group configuration information which includes conditions of applications constituting application groups, to execute a process. The process comprises an application group configuration step of configuring the application groups based on the group configuration information in the group configuration information storing unit and the application information in the application information storing unit, a target application detection step of detecting added, deleted, or changed applications from the application groups configured in the application group configuration step as target applications, and a group operation execution step of performing group operations regarding distribution or deletion of the target applications detected in the target application detection step to the devices.

As such, the computer reads the program from the recording medium and executes the process according to the program read. Thus, the same operations and advantages as those in the application management system of the sixteenth aspect are obtained.

Meanwhile, in order to achieve the above-mentioned object, there is provided a service providing method of a thirty ninth aspect, in which a plurality of devices are communicably connected to each other and which provide a service to at least one device of the plurality of communicably connected devices. The service providing method comprises a device group configuration step of configuring device groups based on group configuration information, which includes device conditions of the device groups, stored in a group configuration information storing unit and device information, which indicates attributes of the communicably connected devices, stored in a device information storing unit, a target device detection step of detecting added, deleted, or changed devices from the device groups configured in the device group configuration step as target devices, and a service provision step of providing the service to the target devices detected in the target device detection step.

As such, the same advantages as those in the service providing system of the first aspect are obtained.

In addition, there is provided a service providing method of a fortieth aspect, in which devices are communicably connected to each other and which provides any one of a plurality of services to the communicably connected devices. The service providing method comprises a service group configuration step of configuring service groups based on group configuration information, which includes service conditions of the service groups, stored in a group configuration information storing unit and service information, which indicates attributes of the services for every service, stored in a device information storing unit, a target service detection step of detecting added, deleted, or changed services from the service groups configured in the service group configuration step as target services, and a service provision step of providing the target services detected in the target service detection step to the devices.

As such, the same advantages as those in the service providing system of the second aspect are obtained.

Meanwhile, in order to achieve the above-mentioned aspect, there is provided an application management method of a forty-first aspect, in which a plurality of devices are communicably connected to each other and which manages applications of the plurality of communicably connected devices. The application management method comprises a device group configuration step of configuring device groups based on group configuration information, which includes device conditions of the device groups, stored in a group configuration information storing unit and device information, which indicates attributes of the communicably connected devices, stored in a device information storing unit, a target device detection step of detecting added, deleted, or changed devices from the device groups configured in the device group configuration step as target devices, and a group operation execution step of performing group operations regarding distribution or deletion of the applications to the target devices detected in the target device detection step.

As such, the same advantages as those in the application management system of the third aspect are obtained.

In addition, in an application management method of a forty-second aspect according to the forty-first aspect, the group configuration information includes conditions of applications constituting application groups. The application management method further comprises an application group configuration step of configuring the application groups based on the group configuration information in the group configuration information storing unit and application information, which indicates attributes of applications for every application, stored in an application information storing unit. In addition, the group operation execution step specifies the application groups corresponding to the device groups to which the target devices belong, based on the group related information in the group related information storing unit which stores group related information which indicates a correspondence relationship between the device groups and the application groups, and performs the group operations relating to the applications, which belong to the specified application groups, on the target devices.

According to the above construction, the same advantages as those in the application management system of the fourth aspect are obtained.

In addition, an application management method of a forty-third aspect according to the forty-second aspect further comprises an application detection step of detecting added, deleted, or changed applications from the application groups configured in the application group configuration step as target applications. Further, in the group operation execution step, the device groups corresponding to the application groups to which the target applications detected by the target application detecting unit belong are specified based on the group related information in the group related information storing unit and the group operations relating to the target applications are performed on the devices which belong to the specified device groups.

As such, the same advantages as those in the application management system of the fifth aspect are obtained.

In an application management method of a forty-fourth aspect according to any one of the forty-first to forty-third aspects, in the group operation execution step, the applications stored in an application storing unit are distributed to target devices, to which the applications are to be added or of which applications are to be changed.

As such, the same advantages as those in the application management system of the sixth aspect are obtained.

In an application management method of a forty-fifth aspect according to any one of the forty-first to forty-fourth aspects, in the group operation execution step, an application deletion command is transmitted to the target devices, of which applications are to be deleted or changed.

As such, the same advantages as those in the application management system of the seventh aspect are obtained.

In an application management method of a forty-sixth aspect according to any one of the forty-first to forty-fifth aspects, the target device detection step and the group operation execution step are performed when a registration, deletion, or change of the device information is performed on the device information storing unit.

As such, the same advantages as those in the application management system of the eighth aspect are obtained.

In an application management method of a forty-seventh aspect according to any one of the forty-first to forty-sixth aspects, the target device detection step and the group operation execution step are performed when a change of the group configuration information is performed on the group configuration information storing unit.

As such, the same advantages as those in the application management system of the ninth aspect are obtained.

In an application management method of a forty-eighth aspect according to any one of the forty-first to forty-seventh aspects, the target device detection step and the group operation execution step are performed at predetermined intervals.

As such, the same advantages as those in the application management system of the tenth aspect are obtained.

In an application management method of a forty-ninth aspect according to any one of the forty-first to forty-eighth aspects, the target device detection step and the group operation execution step are performed when an execution request is input.

As such, the same advantages as those in the application management system of the eleventh aspect are obtained.

In an application management method of a fiftieth aspect according to any one of the forty-third to forty-fifth aspects, the target application detection step and the group operation execution step are performed when the registration, deletion, or change of the application information is performed on the application information storing unit.

As such, the same advantages as those in the application management system of the twelfth aspect are obtained.

In an application management method of a fifty-first aspect according to any one of the forty-third to forty-fifth and fortieth aspects, the target application detection step and the group operation execution step are performed when the change of the group configuration information is performed on the group configuration information storing unit.

As such, the same advantages as those in the application management system of the thirteenth aspect are obtained.

In an application management method of a fifty-second aspect according to any one of the forty-third to forty-fifth, fiftieth and fifty-first aspects, the target application detection step and the group operation execution step are performed at predetermined intervals.

As such, the same advantages as those in the application management system of the fourteenth aspect are obtained.

In an application management method of a fifty-third aspect according to any one of the forty-third to forty-fifth, and fiftieth to fifty-second aspects, the target application detection step and the group operation execution step are performed when an execution request is input.

As such, the same advantages as those in the application management system of the fifteenth aspect are obtained.

In addition, there is provided an application management method of a fifty-fourth aspect, in which devices are communicably connected to each other and which manages applications of the communicably connected devices. The application management method comprises an application group configuration step of configuring application groups based on group configuration information, which includes conditions of applications of the application groups, stored in a group configuration information storing unit and application information, which indicates attributes of the application for every application, stored in an application information storing unit, a target application detection step of detecting added, deleted, or changed applications from the application groups configured in the application group configuration step as target applications, and a group operation execution step of performing group operations regarding distribution or deletion of the target applications detected in the target application detection step to the devices.

As such, the same advantages as those in the application management system of the sixteenth aspect are obtained.

### BRIEF DESCRIPTION OF THE DRAWINGS

FIG. 1 is a functional block diagram schematically showing functions of a network system to which the present invention is applied.

FIG. 2 is a block diagram showing a hardware configuration of a device management terminal 200.

FIG. 3 is a diagram showing a data structure of a device information registration table 400.

FIG. 4 is a diagram showing a data structure of an application information registration table 420.

FIG. 5 is a diagram showing a data structure of a group configuration information registration table 440.

FIG. 6 is a diagram showing a data structure of a group related information registration table 460.

FIG. 7 is a diagram showing a data structure of a group state information registration table 480.

FIG. 8 is a flowchart showing a device setting process.

FIG. 9 is a flowchart showing an application setting process.

FIG. 10 is a flowchart showing a group configuration setting process.

FIG. 11 is a flowchart showing a group related setting process.

FIG. 12 is a flowchart showing an application management process.

FIG. 13 is a block diagram showing a hardware configuration of an application distribution terminal 300.

FIG. 14 is a flowchart showing an application distribution process.

FIG. 15 is a flowchart showing an application deletion process.

FIG. 16 is a diagram illustrating a case in which a registration, deletion, or change of device information is performed on the device information registration table 400.

FIG. 17 is a diagram showing registration contents of the group state information registration table 480.

FIG. 18 is a diagram illustrating a case in which a registration, deletion, or change of application information is performed on the application information registration table 420.

FIG. 19 is a diagram showing registration contents of the group state information registration table 480.

FIG. 20 is a flowchart showing a group operation execution start process.

FIG. 21 is a flowchart showing a group operation execution start process.

FIG. 22 is a diagram showing a recording medium and its data structure.

### DETAILED DESCRIPTION

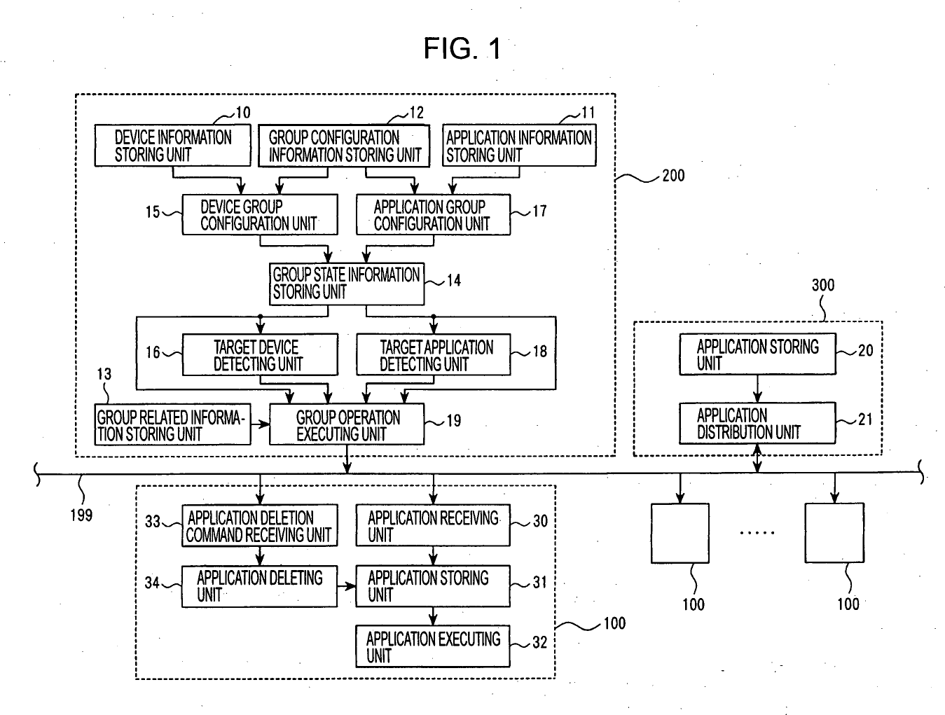

Hereinafter, embodiments of the present invention will be described with reference to the drawings. FIGS. 1 to 19 are diagrams showing embodiments of a service providing system, an application management system, a service providing apparatus, a service providing program, an application management program, a recording medium, a service providing method, an application management method according to the present invention.

The present embodiment relates to the service providing system, the application management system, the service providing apparatus, the service providing program, the application management program, the recording medium, the service providing method, and the application management method according to the present invention which is applied in a case of managing applications of devices 100, as shown in FIG. 1.

To begin with, functions of a network system to which the present invention is applied will be described schematically with reference to FIG. 1.

FIG. 1 is a functional block diagram schematically showing functions of a network system to which the present invention is applied.

As shown in FIG. 1, to the Internet 199, a plurality of devices 100 on which applications can be executed, a device management terminal 200 for managing the devices 100, and an application distribution terminal 300 for distributing applications to the devices 100 are connected.

The device management terminal 200 has a device information storing unit 10 for storing device information which indicates attributes of the devices 100 for every device, an application information storing unit 11 for storing application information which indicates attributes of the applications for every application, and a group configuration information storing unit 12 for storing group configuration information which includes conditions of the devices 100 constituting device groups and conditions of the applications constituting application groups.

The device management terminal 200 further has a group related information storing unit 13 for storing group related information which indicates a correspondence relationship between the device groups and the application groups and a group state information storing unit 14 for storing group state information.

The device management terminal 200 further has a device group configuration unit 15 for configuring the device groups and a target device detecting unit 16 for detecting added, deleted, or changed devices 100 from the device groups as target devices based on the group state information in the group state information storing unit 14.

The device group configuration unit 15 configures the device groups based on the group configuration information in the group configuration information storing unit 12 and the device information in the device information storing unit 10 and registers the group state information, which indicates states of the configured device groups, in the group state information storing unit 14.

The device management terminal 200 further has an application group configuration unit 17 for configuring the application groups and a target application detecting unit 18 for detecting added, deleted, or changed applications from the application groups as target applications based on the group state information in the group state information storing unit 14.

The application group configuration unit 17 configures the application groups based on the group configuration information in the group configuration information storing unit 12 and the application information in the application information storing unit 11 and registers the group state information, which indicates states of the configured application groups, in the group state information storing unit 14.

The device management terminal 200 further has a group operation executing unit 19 for performing operations (hereinafter, referred to as group operations) regarding distribution or deletion of the applications to the devices 100.

The group operation executing unit 19 specifies the application groups corresponding to the device groups, to which the target devices belong, based on the group related information in the group related information storing unit 13 and performs the group operation relating to the applications, which belong to the specified application groups, to the target devices. Further, based on the group related information in the group related information storing unit 13, the group operation executing unit 19 specifies the device groups corresponding to the application groups to which the target applications belong and performs the group operations relating to the target applications to the devices 100 which belong to the specified device groups.

The application distribution terminal 300 has an application storing unit 20 for storing a plurality of applications and an application distribution unit 21 for distributing the applications in the application storing unit 20 to the devices 100.

The application distribution unit 21 distributes the applications in the application storing unit 20 to the devices 100 when a distribution request of the applications is received from the device management terminal 200 and transmits an application deletion command to the devices 100 when an application deletion request is received from the device management terminal 200.

Each device 100 has an application receiving unit 30 for receiving the applications, an application storing unit 31 for storing the applications received by the application receiving unit 30, an application executing unit 32 for executing the applications in the application storing unit 31, an application deletion command receiving unit 33 for receiving an application deletion command, an application deleting unit 34 for deleting the applications in the application storing unit 31 according to the application deletion command received by the application deletion command receiving unit 33.

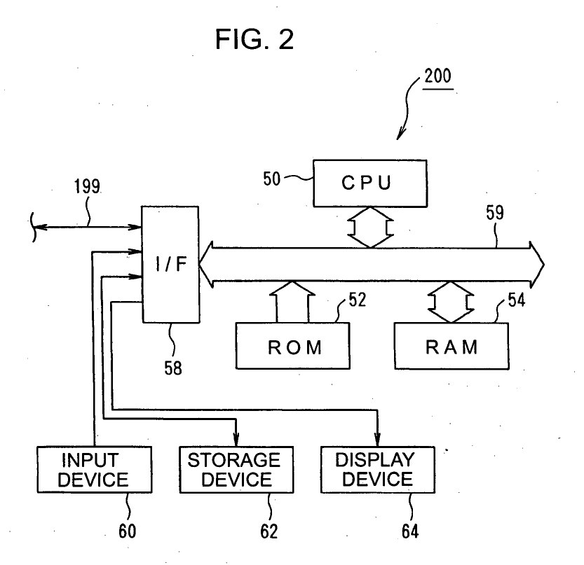

Next, a configuration of the device management terminal 200 will be described in detail with reference to FIGS. 2 to 12.

FIG. 2 is a block diagram showing a hardware configuration of the device management terminal 200.

As shown in FIG. 2, the device management terminal 200 comprises a CPU 50 for controlling arithmetic and an overall system based on a control program, a ROM 52 for pre-storing the control program of the CPU 50 or the like in a predetermined region, a RAM 54 for storing data read from the ROM 52 or the like, or arithmetic results required for an arithmetic process of the CPU 50, an I/F 58 for intermediating output and input of data to an external device. These elements are connected to each other to transmit and receive data via a bus 59 which is a signal line for transferring data.

To the I/F 58, as an external device, an input device 60 comprising a keyboard or a mouse which can input data as a human interface, a storage device 62 which stores data or tables as a file, a display device 64 which displays a screen based on image signals, and a signal line for connecting to a network such as the Internet 199 are connected.

The storage device 62 comprises the device information storing unit 10, the application information storing unit 11, the group configuration information storing unit 12, the group related information storing unit 13 and the group state information storing unit 14.

The storage device 62 stores a device information registration table 400 in which the device information is registered for every device 100.

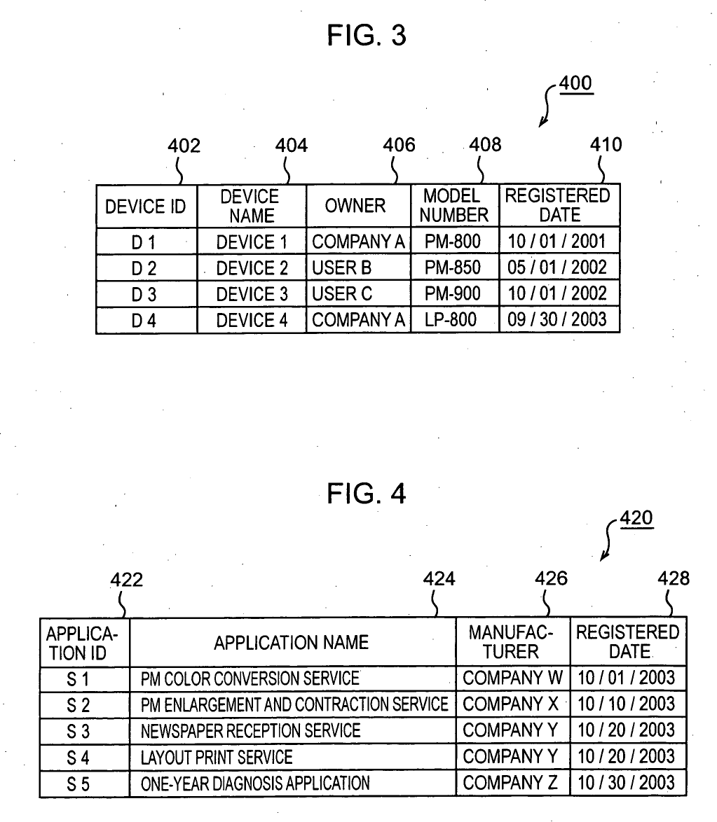

FIG. 3 is a diagram showing a data structure of the device information registration table 400.

In the device information registration table 400, as shown in FIG. 3, one record is registered for every device 100. Each record comprises a field 402 in which a device ID uniquely assigned to each device 100 is registered, a field 404 in which a name of each device 100 is registered, a field 406 in which an owner of each device 100 is registered, a field 408 in which a model number of each device 100 is registered, and a field 410 in which a registered date of each device 100 is registered.

Referring to an example of FIG. 3, in a first stage record, ‘D1’ as the device ID, ‘DEVICE 1’ as the device name, ‘COMPANY A’ as the owner, ‘PM-800’ as the model number, and ‘Oct. 1, 2001’ as the registered date are registered respectively. This indicates that the device name, the owner, the model number of the device 100 which is specified by the device ID ‘D1’ are ‘DEVICE 1’, ‘COMPANY A’, and ‘PM-800’ respectively and the device information of the device 100 is registered on ‘Oct. 1, 2001’.

The storage device 62 further stores an application information registration table 420 in which the application information is registered for every application.

FIG. 4 is a diagram showing a data structure of the application information registration table 420.

In the application information registration table 420, as shown in FIG. 4, one record is registered for every application. Each record comprises a field 422 in which an application ID assigned to each application is registered, a field 424 in which a name of each application is registered, a field 426 in which a manufacturer of each application is registered, and a field 428 in which a registered date of the application information is registered.

Referring to an example of FIG. 4, in a first stage record, ‘S1’ as the application ID, ‘PM COLOR CONVERSION SERVICE’ as the application name, ‘COMPANY W’ as the manufacturer, and ‘Oct. 1, 2003’ as the registered date are registered respectively. This indicates that the application name and the manufacturer which is specified by the application ID ‘S1’ are ‘APPLICATION 1’ and ‘COMPANY 1’ respectively and the application information of the application is registered on ‘Oct. 1, 2003’.

The storage device 62 further stores a group configuration information registration table 440 in which the group configuration information is registered for every device group or application group.

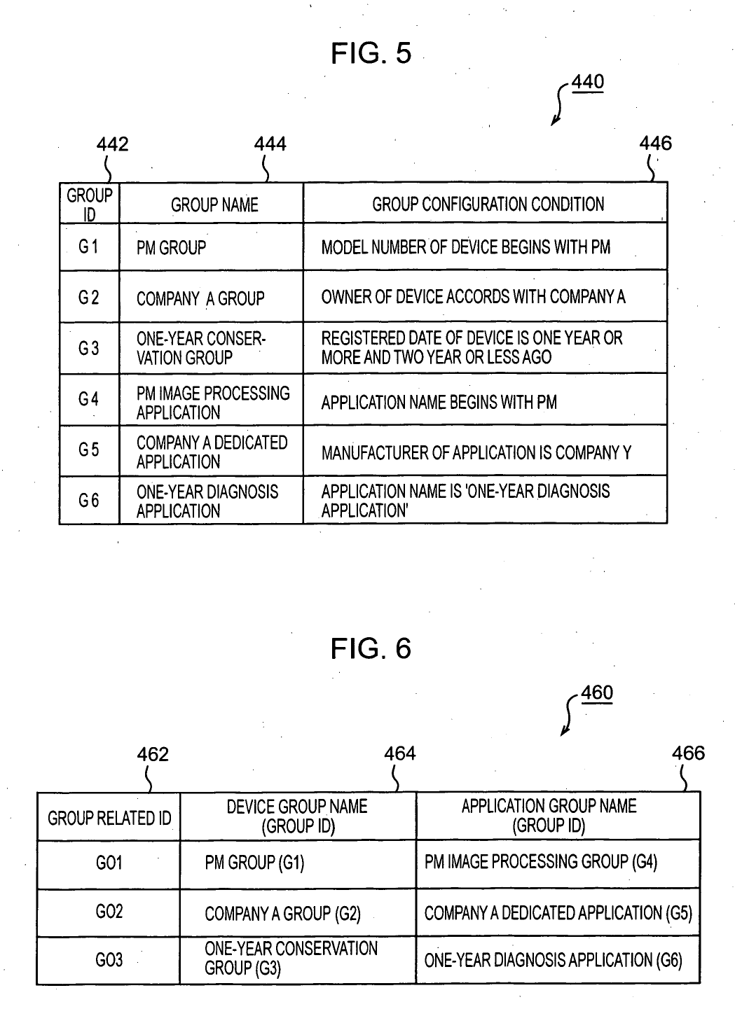

FIG. 5 is a diagram showing a data structure of the group configuration information registration table 440.

In the group configuration information registration table 440, as shown in FIG. 5, one record is registered for every device group or application group. Each record comprises a field 442 in which a group ID assigned to each device group or application group is registered, a field 444 in which a name of each device group or application group is registered, and a field 446 in which a group configuration condition constituting each device group or application group is registered.

Referring to an example of FIG. 5, in a first stage record, ‘G1’ as the group ID, ‘PM GROUP’ as the group name, and ‘MODEL NUMBER OF DEVICE BEGINS WITH PM’ as the group configuration condition are registered respectively. This indicates that the group name which is specified by the group ID ‘G1’ is ‘PM GROUP’ and the devices 100 of which model numbers begin with ‘PM’ belong to the device group.

Further, in a fourth stage record, ‘G4’ as the group ID, ‘PM IMAGE PROCESSING APPLICATION’ as the group name, and ‘APPLICATION NAME BEGINS WITH PM’ as the group configuration condition are registered respectively. This indicates that the group name which is specified by the group ID ‘G4’ is ‘PM IMAGE PROCESSING APPLICATION’ and the applications of which application names begin with ‘PM’ belong to the application group.

The storage device 62 further stores a group related information registration table 460 in which the group related information is registered for every device group.

FIG. 6 is a diagram showing a data structure of the group related information registration table 460.

In the group related information registration table 460, as shown in FIG. 6, one record is registered for every device group. Each record comprises a field 462 in which a group relation ID assigned to a correspondence relationship between each device group and each application group is registered, a field 464 in which the name of each device group and the group ID are registered, and a field 466 in which the name of each application and the group ID are registered.

Referring to an example of FIG. 6, in a first stage record, ‘G1’ as the group relation ID, ‘PM GROUP (G1)’ as the device group name and the group ID, and ‘PM IMAGE PROCESSING APPLICATION (G4)’ as the application group name and the group ID are registered respectively. This indicates that the device group which is specified by the group ID ‘G1’ corresponds to the application group which is specified by the group ID ‘G4’. That is, to the device 100 belonging to the device group which is specified by the group ID ‘G1’, the group operation regarding the application belonging to the application group which is specified by the group ID ‘G4’ is performed.

The storage device 62 further stores a group state information registration table 480 in which the group state information is registered for every device group or application group.

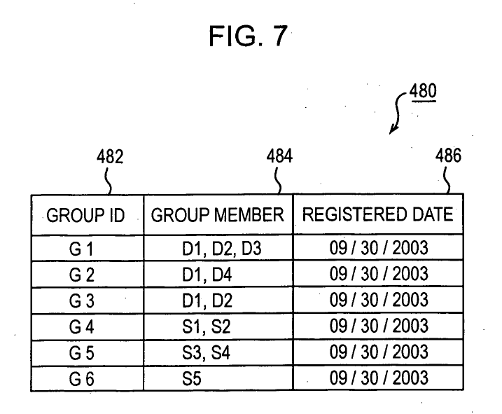

FIG. 7 is a diagram showing a data structure of the group state information registration table 480.

In the group state information registration table 480, as shown in FIG. 7, one record is registered for every device group or application group. Each record comprises a field 482 in which the group ID is registered, a field 484 in which a group member of each device group or application group is registered, and a field 486 in which a registered date of the group state information is registered.

Referring to an example of FIG. 7, in a first stage record, ‘G1’ as the group ID, ‘D1, D2, D3’ as the group member, and ‘Sep. 30, 2003’ as the registered date are registered respectively. This indicates that three devices 100 which are specified by the device IDs ‘D1, D2, D3’ belong to the device group which is specified by the group ID ‘G1’ on ‘Sep. 30, 2003’.

Further, in a fourth stage record, ‘G4’ as the group ID, ‘S1, S2’ as the group member, and ‘Sep. 30, 2003’ as the registered date are registered respectively. This indicates that two applications which are specified by the application IDs ‘S1, S2’ belong to the application group which is specified by the group ID ‘G4’ on ‘Sep. 30, 2003’.

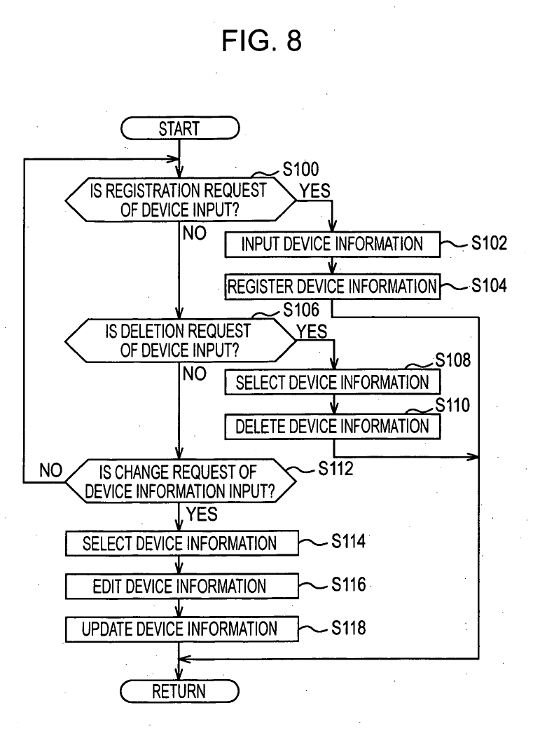

Returning to FIG. 2, the CPU 50 comprises a micro processing unit (MPU) and starts a predetermined program which is stored in a predetermined region of the ROM 52. Further, the CPU 50 executes a device setting process, an application setting process, a group configuration setting process, a group relation setting process, and an application management process shown in flowcharts of FIGS. 8 to 12 in a time sharing manner according to the program.

First, the device setting process will be described in detail with reference to FIG. 8.

FIG. 8 is a flowchart showing the device setting process.

The device setting process is a process in which the device information of the device information registration table 400 is registered, deleted or changed. If the device setting process is executed by the CPU 50, first, the process progresses to the step S100 as shown in FIG. 8.

In the step S100, it is determined whether or not a registration request of the device 100 is input from the input device 60. If it is determined that the registration request is input (Yes), the process progresses to the step S102.

In the step S102, the device information of the device 100 to be registered is input from the input device 60, and then the process progresses to the step S104. In the step S104, the input device information is registered in the device information registration table 400. Then, a series of steps end, and the process returns to the previous state.

Meanwhile, in the step S100, if it is determined that the registration request of the device 100 is not input (No), the process progresses to the step S106. In the step S106, it is determined whether or not a deletion request of the device 100 is input from the input device 60. If it is determined that the deletion request is input (Yes), the process progresses to the step S108.

In the step S108, the administrator is allowed to select the device information to be deleted from the device information registration table 400 via the input device 60, and the process progresses to the step S110. In the step S110, the selected device information is deleted from the device information registration table 400. Then, a series of steps end, and the process returns to the previous state.

Meanwhile, in the step S106, if it is determined that the deletion request of the device 100 is not input (No), the process progresses to the step S112. In the step S112, it is determined whether or not a change request of the device information is input from the input device 60. If it is determined that the change request is input (Yes), the process progresses to the step S114.

In the step S114, the administrator is allowed to select the device information to be changed from the device information registration table 400 via the input device 60, and then the process progresses to the step S116. In the step S116, the administrator is allowed to edit the selected device information via the input device 60, and then the process progresses to the step S118. In the step S118, the device information of the device information registration table 400 is updated based on the edition result. Then, a series of steps end, and the process returns to the previous state.

Meanwhile, in the step S112, if it is determined that the change request of the device information is not input (No), the process progresses to the step S100.

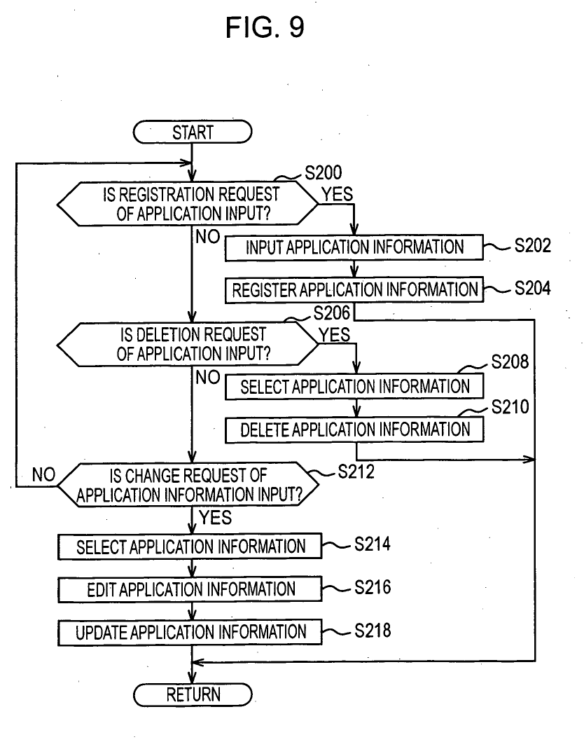

Next, the application setting process will be described in detail with reference to FIG. 9.

FIG. 9 is a flowchart showing the application setting process.

The application setting process is a process in which the application information of the application information registration table 420 is registered, deleted or changed. If the application setting process is executed by the CPU 50, first, the process progresses to the step S200 as shown in FIG. 9.

In the step S200, it is determined whether or not a registration request of an application is input from the input device 60. If it is determined that the registration request is input (Yes), the process progresses to the step S202.

In the step S202, the application information of the application to be registered is input from the input device 60, and then the process progresses to the step S204. In the step S204, the input application information is registered in the application information registration table 420. Then, a series of steps end, and the process returns to the previous state.

Meanwhile, in the step S200, if it is determined that the registration request of the application is not input (No), the process progresses to the step S206. In the step S206, it is determined whether or not a deletion request of an application is input from the input device 60. If it is determined that the deletion request is input (Yes), the process progresses to the step S208.

In the step S208, the administrator is allowed to select the application information to be deleted from the application information registration table 420 via the input device 60, and then the process progresses to the step S210. In the step S210, the selected application information is deleted from the application information registration table 420. Then, a series of steps end, and the process returns to the previous state.

Meanwhile, in the step S206, if it is determined that the deletion request of the application is not input (No), the process progresses to the step S212. In the step S212, it is determined whether or not a change request of the application information is input from the input device 60. If it is determined that the change request is input (Yes), the process progresses to the step S214.

In the step S214, the administrator is allowed to select the application information to be changed from the application information registration table 420 via the input device 60, and then the process progresses to the step S216. In the step S216, the administrator is allowed to edit the selected application information via the input device 60, and then the process progresses to the step S218. In the step S218, the application information of the application information registration table 420 is updated based on the edition result. Then, a series of steps end, and the process returns to the previous state.

Meanwhile, in the step S212, if it is determined that the change request of the application information is not input (No), the process progresses to the step S200.

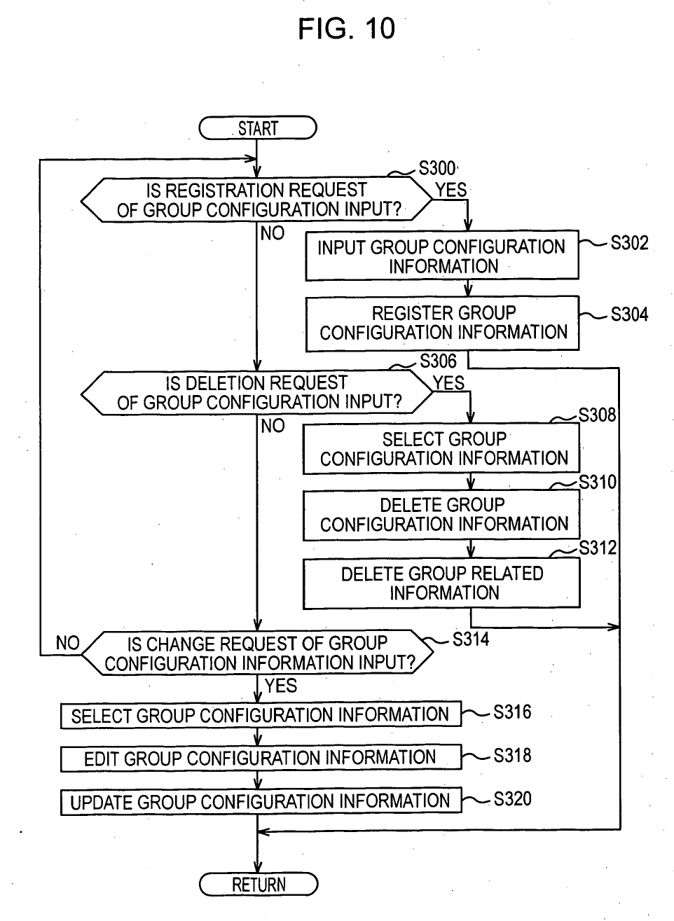

Next, the group configuration setting process will be described in detail with reference to FIG. 10.

FIG. 10 is a flowchart showing the group configuration setting process.

The group configuration setting process is a process in which the group configuration information of the group configuration information registration table 440 is registered, deleted or changed. If the group configuration setting process is executed by the CPU 50, first, the process progresses to the step S300 as shown in FIG. 10.

In the step S300, it is determined whether or not a registration request of a group configuration is input from the input device 60. If it is determined that the registration request is input (Yes), the process progresses to the step S302.

In the step S302, the group configuration information of the group configuration to be registered is input from the input device 60, and then the process progresses to the step S304. In the step S304, the input group configuration information is registered in the group configuration information registration table 440. Then, a series of steps end, and the process returns to the previous state.

Meanwhile, in the step S300, if it is determined that the registration request of the group configuration is not input (No), the process progresses to the step S306. In the step S306, it is determined whether or not a deletion request of a group configuration is input from the input device 60. If it is determined that the deletion request is input (Yes), the process progresses to the step S308.

In the step S308, the administrator is allowed to select the group configuration information to be deleted from the group configuration information registration table 440 via the input device 60, and then the process progresses to the step S310. In the step S310, the selected group configuration information is deleted from the group configuration information registration table 440, and then process progresses to the step S312. In the step S312, the group related information associating the group of the selected group configuration information with each other is deleted from the group related information registration table 460. Then, a series of steps end, and the process returns to the previous state.

Meanwhile, in the step S306, if it is determined that the deletion request of the group configuration is not input (No), the process progresses to the step S314. In the step S314, it is determined whether or not a change request of the group configuration information is input from the input device 60. If it is determined that the change request is input (Yes), the process progresses to the step S316.

In the step S316, the administrator is allowed to select the group configuration information to be changed from the group configuration information registration table 440 via the input device 60, and then the process progresses to the step S318. In the step S318, the administrator is allowed to edit the selected group configuration information via the input device 60, and then the process progresses to the step S320. In the step S320, the group configuration information of the group configuration information registration table 440 is updated based on the edition result. Then, a series of steps end, and the process returns to the previous state.

Meanwhile, in the step S314, if it is determined that the change request of the group configuration information is not input (No), the process progresses to the step S300.

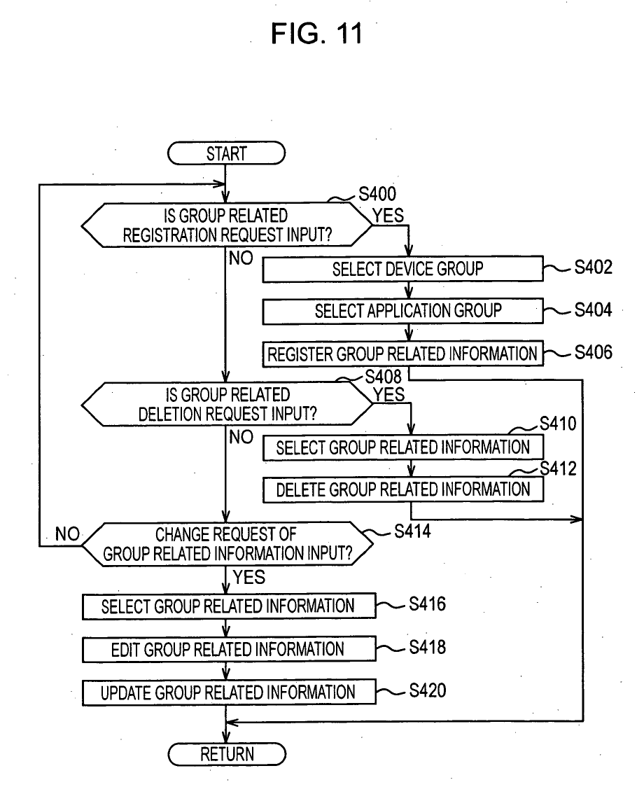

Next, the group relation setting process will be described in detail with reference to FIG. 11.

FIG. 11 is a flowchart showing the group relation setting process.

The group relation setting process is a process in which the group related information of the group related information registration table 460 is registered, deleted or changed. If the group relation setting process is executed by the CPU 50, first, the process progresses to the step S400 as shown in FIG. 11.

In the step S400, it is determined whether or not a registration request of a group relation is input from the input device 60. If it is determined that the registration request is input (Yes), the process progresses to the step S402.

In the step S402, the administrator is allowed to select a device group to be registered from the group configuration information registration table 440 via the input device 60, and then the process progresses to the step S404. In the step S404, the administrator is allowed to select an application to be registered from the group configuration information registration table 440 via the input device 60, and then the process progresses to the step S406. In the step S406, the group related information which indicates a correspondence relationship between the selected device group and application group is registered in the group related information registration table 460. Then, a series of steps end, and the process returns to the previous state.

Meanwhile, in the step S400, if it is determined that the registration request of the group relation is not input (No), the process progresses to the step S408. In the step S408, it is determined whether or not a deletion request of a group relation is input from the input device 60. If it is determined that the deletion request is input (Yes), the process progresses to the step S410.

In the step S410, the administrator is allowed to select the group related information to be deleted from the group related information registration table 460 via the input device 60, and then the process progresses to the step S412. In the step S412, the selected group related information is deleted from the group related information registration table 460. Then, a series of steps end, and the process returns to the previous state.

Meanwhile, in the step S408, if it is determined that the deletion request of the group relation is not input (No), the process progresses to the step S414. In the step S414, it is determined whether or not a change request of the group related information is input from the input device 60. If it is determined that the change request is input (Yes), the process progresses to the step S416.

In the step S416, the administrator is allowed to select the group related information to be changed from the group related information registration table 460 via the input device 60, and then the process progresses to the step S418. In the step S418, the administrator is allowed to edit the selected group related information via the input device 60, and then the process progresses to the step S420. In the step S420, the group related information of the group related information registration table 460 is updated based on the edition result. Then, a series of steps end, and the process returns to the previous state.

Meanwhile, in the step S414, if it is determined that the change request of the group related information is not input (No), the process progresses to the step S400.

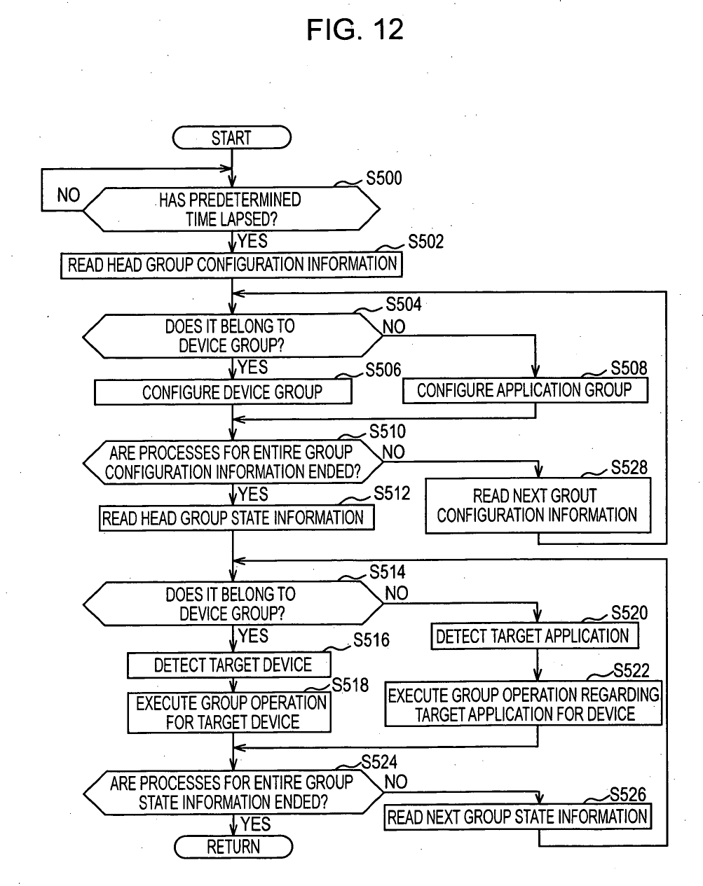

Next, the application management process will be described in detail with reference to FIG. 12.

FIG. 12 is a flowchart showing the application management process.

The application management process is a process which is realized by the device group configuration unit 15, the target device detecting unit 16, the application group configuration unit 17, the target application detecting unit 18 and the group operation executing unit 19. If the application management process is executed by the CPU 50, first, the process progresses to the step S500 as shown in FIG. 12.

In the step S500, it is determined whether or not a predetermined time (for example, one day) lapsed from a previous execution time. If it is determined that the predetermined time lapsed (Yes), the process progresses to the step S502. However, if it is determined that the predetermined time did not lapse (No), the process waits in the step S500 until the predetermined time lapses.

In the step S502, the head group configuration information is read from the group configuration information registration table 440, and then the process progresses to the step S504. In the step S504, it is determined whether or not the read group configuration information belongs to the device group. If it is determined that it is the group configuration information of the device group (Yes), the process progresses to the step S506.

In the step S506, the device group is configured based, on the read group configuration information. More specifically, first, the device information satisfying the group configuration condition of the read group configuration information is retrieved from the device information registration table 400 and the device ID is acquired from the retrieved device information. Then, the group ID of the device group to be configured is created and the created group ID and the acquired device ID are registered as the group state information in the group state information registration table 480.

Meanwhile, in the step S504, if it is determined that the read group configuration information does not belong to the device group (No), the process progresses to the step S508.

In the step S508, the application group is configured based on the read group configuration information. More specifically, first, the application information satisfying the group configuration condition of the read group configuration information is retrieved from the application information registration table 420 and the application ID is acquired from the retrieved application information. Then, the group ID of the application group to be configured is created and the created group ID and the acquired application ID are registered as the group state information in the group state information registration table 480.

Next, if the steps S506 and S508 end, the process progresses to the step S510. In the step S510, it is determined whether or not the steps S504 to S508 end for the entire group configuration information of the group configuration information registration table 440. If it is determined that the steps S504 to S508 end for the entire group configuration information (Yes), the process progresses to the step S512.

In the step S512, a head of the group state information registered at the steps S506 and S508 is read from the group state information registration table 480, and the process progresses to the step S514. In the step S514, it is determined whether or not the read group state information belongs to the device group. If it is determined that it is the group state information of the device group (Yes), the process progresses to the step S516.

In the step S516, the added, deleted, or changed devices 100 from the device group configured in the step S506 are detected as the target devices based on the read group state information, and then the process progresses to the step S518.

In the step S518, the group operations are performed on the target devices. More specifically, with reference to the group related information registration table 460, the application group corresponding to the device group to which the target device belongs is retrieved. Then, the group operations relating to the applications which belong to the retrieved application group are performed on the target devices. Here, as the group operations, for the target devices, to which the applications are to be added or of which application are to be changed, the application distribution list in which the application information of the applications to be distributed is registered in association with network addresses of the target devices is transmitted to the application distribution terminal 300, together with the application distribution request. Further, for the target devices, of which applications are to be deleted or changed, the application deletion list in which the application information of the applications to be deleted is registered in association with the network addresses of the target devices is transmitted to the application distribution terminal 300, together with the application deletion request.

Meanwhile, in the step S514, if it is determined that the read group state information does not belong to the device group (No), the process progresses to the step S520.

In the step S520, the added, deleted, or changed applications from the application groups configured in the step S508 are detected as the target applications based on the read group state information. Then, the process progresses to the step S522.

In the step S522, the group operations relating to the target applications are performed on the devices. More specifically, with reference to the group related information registration table 460, the device group corresponding to the application group to which the target applications belong is retrieved. Then, the group operation relating to the target applications are performed on the devices 100 which belong to the retrieved device group. Here, as the group operations, for the target applications to be added or changed, the application distribution list in which the application information of the target applications is registered in association with the network addresses of the devices 100 to be distributed is transmitted to the application distribution terminal 300, together with the application distribution request. Further, for the target application to be deleted or changed, the application deletion list in which the application information of the target applications is registered in association with the network addresses of the devices 100 to be deleted is transmitted to the application distribution terminal 300, together with the application deletion request.

Next, if the steps S518 and S522 end, the process progresses to the step S524. In the step S524, it is determined whether or not the steps S514 to S522 end for the entire group state information registered in the steps S506 and S508. If it is determined that the steps S514 to S522 end for the entire group state information (Yes), a series of steps end, and the process returns to the previous state.

Meanwhile, in the step S524, if it is determined that the steps S514 to S522 do not end for the entire group state information (No), the process progresses to the step S526. In the step S526, the next group state information registered in the steps S506 and S508 is read from the group state information registration table 480, and then the process progresses to the step S514.

Meanwhile, in the step S510, if it is determined that the steps 504 to 508 do not end for the entire group configuration information (No), the process progresses to the step S528. In the step S528, the next group configuration information is read from the group configuration information registration table 440, and then the process progresses to the step S504.

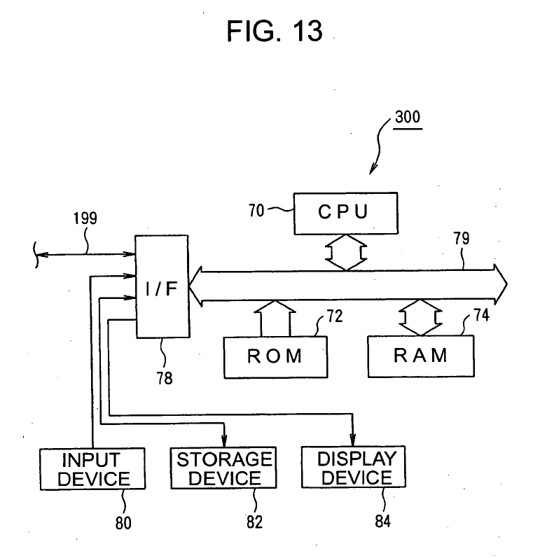

Next, a configuration of the application distribution terminal 300 will be described in detail with reference to FIGS. 13 to 15.

FIG. 13 is a block diagram showing a hardware configuration of the application distribution terminal 300.

As shown in FIG. 13, the application distribution terminal 300 comprises a CPU 70 for controlling arithmetic and an overall system based on a control program, a ROM 72 for pre-storing the control program of the CPU 70 or the like in a predetermined region, a RAM 74 for storing data read from the ROM 72 or the like, or arithmetic results required for an arithmetic process of the CPU 70, an I/F 78 for intermediating output and input of data to an external device. These elements are connected to each other to transmit and receive data via a bus 79 which is a signal line for transferring data.

To the I/F 78, as an external device, an input device 80 comprising a keyboard or a mouse which can input data as a human interface, a storage device 82 which stores data or tables as a file, a display device 84 which displays a screen based on image signals, and a signal line for connecting to the Internet 199 are connected.

The storage device 82 comprises the application storing unit 20.

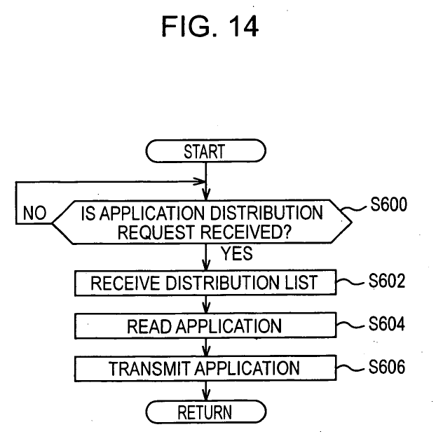

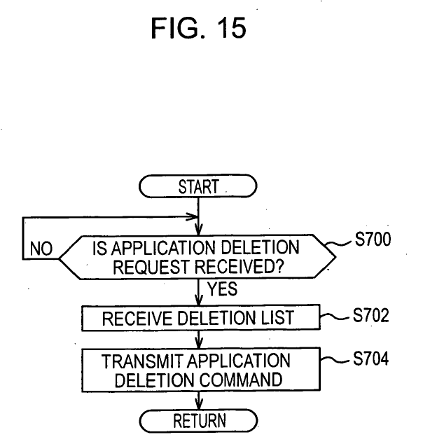

The CPU 70 comprises a micro processing unit (MPU) and starts a predetermined program which is stored in a predetermined region of the ROM 72. Further, the CPU 70 executes an application distribution process and an application deletion process shown in flowcharts of FIGS. 14 and 15 in a time sharing manner according to the program.

First, the application distribution process will be described in detail with reference to FIG. 14.

FIG. 14 is a flowchart showing the application distribution process.

The application distribution process is a process which is realized by an application distribution unit 21. If the application distribution process is executed by the CPU 70, first, the process progresses to the step S600 as shown in FIG. 14.

In the step S600, it is determined whether or not the application distribution request is received. If it is determined that the application distribution request is received (Yes), the process progresses to the step S602. However, if it is determined that the application distribution request is not received (No), the process waits in the step S600 until the application distribution request is received.

In the step S602, the application distribution list is received, and then the process progresses to the step S604. In the step S604, the applications are read from the storage device 82 based on the received application distribution list. Then the process progresses to the step S606 and the read applications are distributed to the devices 100 based on the received application distribution list. Then, a series of steps end, the process returns to the previous state.

Next, the application deletion process will be described in detail with reference to FIG. 15.

FIG. 15 is a flowchart showing the application deletion process.

The application deletion process is a process which is realized by the application distribution unit 21. If the application deletion process is executed by the CPU 70, first, the process progresses to the step S700 as shown in FIG. 15.

In the step S700, it is determined whether or not the application deletion request is received. If it is, determined that the application deletion request is received (Yes), the process progresses to the step S702. However, if it is determined that the application deletion request is not received (No), the process waits in the step S700 until the application deletion request is received.

In the step S702, the application deletion list is received, and then the process progresses to the step S704. In the step S704, the application deletion command is transmitted to the devices 100 based on the received application deletion list. Then, a series of steps end, the process returns to the previous state.

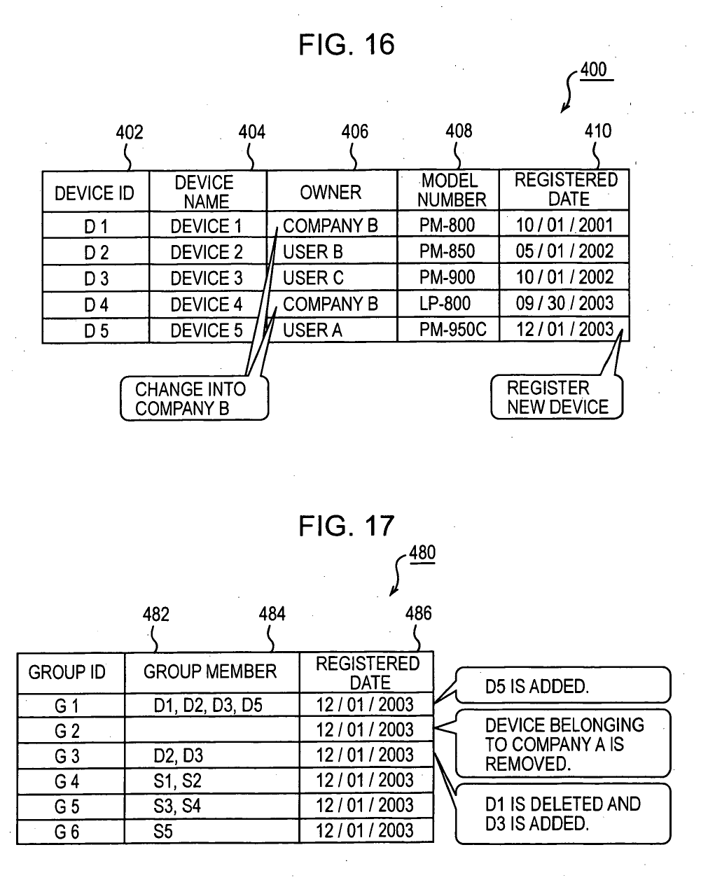

Next, operations of the present embodiment will be described with reference to FIGS. 16 to 19.

To begin with, a case in which the device information is registered, deleted or changed will be described.

In a case of registering the device 100, the administrator inputs the registration request of the device 100 and then the device information of the device 100 to be registered in the device management terminal 200.

In the device management terminal 200, if the device information is input, together with the registration request, the input device information is registered in the device information registration table 400 through the step S104.

In a case of deleting the device 100, the administrator inputs the deletion request of the device 100 and selects the device information to be deleted from the device information registration table 400, in the device management terminal 200.

In the device management terminal 200, if the device information is selected, together with the deletion request, the selected device information is deleted from the device information registration table 400 through the step 110.

Further, in a case of changing the device information, the administrator inputs the change request of the device information in the device management terminal 200 and selects the device information to be changed from the device information registration table 400.

In the device management terminal 200, if the device information is selected, together with the change request, the selected device information is in an editable state through the step S116. Here, if the administrator completes the edition of the device information, through the step S118, the device information of the device information registration table 400 is updated based on the edition result.

Moreover, when the application information is registered, deleted or changed, when the group configuration information is registered, deleted or changed, and when the group related information is registered, deleted or changed, the same sequence of the above-mentioned registration, deletion and change is applied.

Next, as an example in which the device information of the device information registration table 400 is registered, deleted or changed, a case in which the distribution or deletion of the application is performed on the device 100 will be described.

FIG. 16 is a diagram illustrating a case in which a registration, deletion, or change of device information is performed on the device information registration table 400.

It is now assumed that the registration contents of the device information registration table 400 change from the registration contents of FIG. 3 to the registration contents of FIG. 16. In FIG. 16, the owner of each of the device D1 (the device 100 which is specified by the device ID ‘G1’, and hereinafter, similarly referred to as that) and the device D4 change from ‘COMPANY A’ to ‘COMPANY B’, and the device D5 is added. The name, the owner, and the model number of the device D5 are ‘DEVICE 5’, ‘USER A’, and ‘PM-950C’ respectively.

FIG. 17 is a diagram showing the registration contents of the group state information registration table 480.

In the device management terminal 200, if the predetermined time lapses from the previous execution time, through the steps S502 to S506, the group configuration information of the device group G1 (the device group which is specified by the group ID ‘G1’, and hereinafter, similarly referred to as that) is read. Further, the device group G1 is configured based on the read group configuration information and then the group state information indicating the state of the device group G1 is registered. To the device group G1, the devices 100 of which the model numbers begin with ‘PM’ belong. Thus, as shown in FIG. 17, in addition to the existing devices D1, D2 and D3, the new device D5 also belongs to the device group G1.

Next, through the steps S528 and S504 to S506, the group configuration information of the device group G2 is read. Further, based on the read group configuration information, the device group G2 is configured and the group state information indicating the state of the device group G2 is registered. The devices 100 of each of which the owner is ‘COMPANY A’ belong to the device group G2. Thus, as shown in FIG. 17, any one of devices 100 does not belong to the device group G2.

Next, through the steps S528, S504 to S506, the group configuration information of the device group G3 is read. Further, based on the read group configuration information, the device group G3 is configured and the group state information indicating the state of the device group G3 is registered. To the device group G3, the devices 100 of each of which the registered date is one year or more and two year or less ago belong. Thus, as shown in FIG. 17, in addition to the existing the device D2, the new device D3 is added. Further, since the device information of the device D1 changes, the device D1 does not belong to the device group G3.

Next, through the steps S528, S504 and S508, the group configuration information of the application group G4 (the application group which is specified by the group ID ‘G4’, and hereinafter, similarly referred to as that) is read. Further, based on the read group configuration information, the application group G4 is configured and the group state information indicating the state of the application group G4 is registered. For the application groups G5 and G6, the same process is performed. Moreover, the application information of the application groups G4, G5 and G6 does not change and so on. Thus, as shown in FIG. 17, the group members do not change.

Next, through the steps S512 to S516, the group state information of the device group G1 is read. Further, based on the read group state information, the added device D5 from the device group G1 is detected. Next, through the step S518, the application group corresponding to the device group G1 is retrieved. According to the group related information registration table 460 of FIG. 6, the application group G4 satisfies the condition, and thus the application group G4 is retrieved. Then, to the application group G4, the application S1 (the application which is specified by the application ID ‘S1’, and hereinafter, similarly referred to as that) and the application S2 belong. Thus, the group operations relating to the applications S1 and S2 are performed on the device D5. More specifically, the application distribution list in which the application information of the applications S1 and S2 are registered in association with the network address of the device D5 is transmitted to the application distribution terminal 300, together with the application distribution request.

In the application distribution terminal 300, if the application distribution list is received, together with the application distribution request, through the steps S604 and S606, the applications. S1 and S2 are read based on the received application distribution list and the read applications S1 and S2 are distributed to the device D5.

In the device D5, if the applications S1 and S2 are received, the received applications S1 and S2 are stored in the application storing unit 31 and then the applications S1 and S2 of the application storing unit 31 are executed by the application executing unit 32.

Further, in the device management terminal 200, through the steps S526, S514 and S516, the group state information of the device group G2 is read. Further, based on the read group state information, the deleted devices D1 and D4 from the device group G2 are detected. Next, through the step S518, the application group corresponding to the device group G2 is retrieved. According to the group related information registration table 460 of FIG. 6, the application group G5 satisfies the condition, and thus the application group G5 is retrieved. Then, to the application group G5, the applications S3 and S4 belong, and thus the group operations relating to the applications S3 and S4 are performed on the devices D1 and D4. More specifically, the application deletion list, in which the application information of the applications S3 and S4 is registered in association with the network addresses of the devices D1 and D4 respectively, is transmitted to the application distribution terminal 300, together with the application deletion request.

In the application distribution terminal 300, if the application deletion list is received, together with the application deletion request, through the step S704, the application deletion command is distributed to the devices D1 and D4 based on the received application deletion list.

In each of the devices D1 and D4, if the application deletion command is received, the applications S3 and S4 of the application storing unit 31 are deleted by the application deleting unit 34.

Further, in the device management terminal 200, through the steps S526, S514 and S516, the group state information of the device group G3 is read. Further, based on the read group state information, the deleted device D1 and the added device D3 from the device group G3 are detected. Next, through the step S518, the application, group corresponding to the device group G3 is retrieved. According to the group related information registration table 460 of FIG. 6, the application group G6 satisfies the condition, and thus the application group G6 is retrieved. Then, to the application group G6, the application S5 belongs. Thus, the group operations relating to the application S5 are performed on the devices D1 and D3. Therefore, similarly, the application S5 is deleted from the device D1 and the application S5 is incorporated into the device D3.

Further, in the device management terminal 200, through the steps S526, S514 and S520, the group state information of the application group G4 is read. However, in the application group G4, the added, deleted, or changed application does not exist, and thus the group operations are not performed. For the applications group G5 and G6, the same process is performed.

Next, as an example in which the application information of the application information registration table 420 is registered, deleted or changed, a case in which the distribution or deletion of the application is performed on the device 100 will be described.

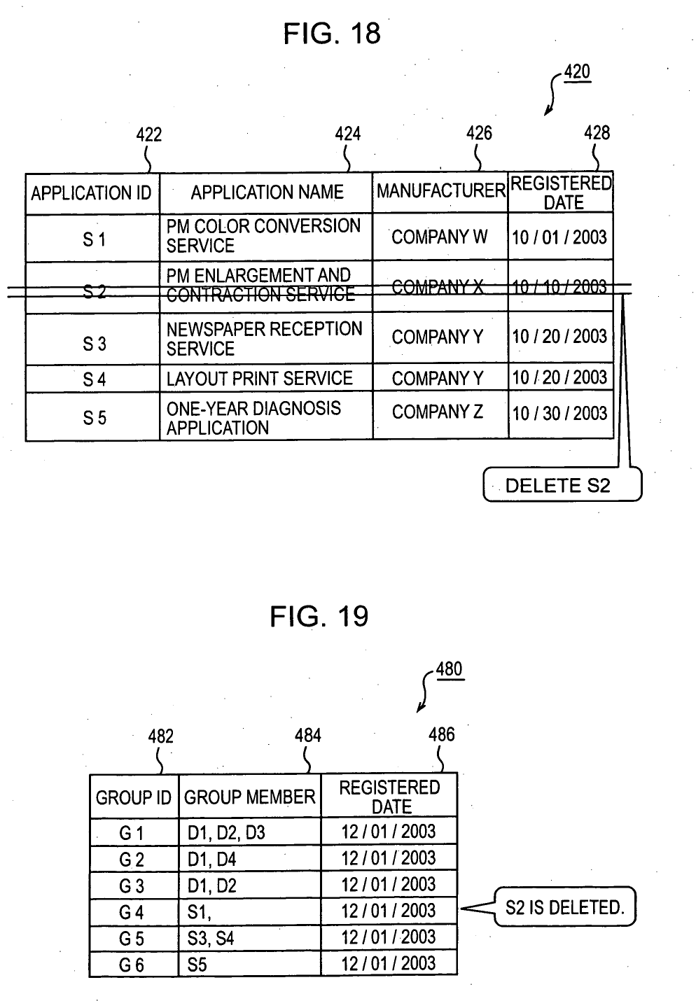

FIG. 18 is a diagram illustrating a case in which a registration, deletion, or change of application information is performed on the application information registration table 420.

It is now assumed that the registration contents of the application information registration table 420 change from the registration contents of FIG. 4 to the registration contents of FIG. 18. In FIG. 18, the application S2 is deleted.

FIG. 19 is a diagram showing the registration contents of the group state information registration table 480.

In the device management terminal 200, if the predetermined time lapses from the previous execution time, through the steps S502 to S506, the group configuration information of the device group G1 is read. Further, based on the read group configuration information, the device group G1 is configured and the group state information indicating the state of the device group G1 is registered. For the device groups G2 and G3, the same process is performed. Moreover, in the device groups G1, G2 and G3, the device information does not change, and thus, as shown in FIG. 19, the group members do not change.

Next, through the steps S528, S504 and S508, the group configuration information of the application group G4 is read. Further, based on the read group configuration information, the application group G4 is configured and the group state information indicating the state of the application group G4 is registered. To the application group G4, the applications of each which the application name begins with ‘PM’ belong. Thus, as shown in FIG. 19, the application S1 belongs to the application group G4. Further, since the application S2 is deleted, the application S2 does not belong to the application group G4.

Next, through the steps S528, S504 and S508, the group configuration information of the application group G5 is read. Further, based on the read group configuration information, the application group G5 is configured and the group state information indicating the state of the application group G5 is registered. For the application group G6, the same process is performed. In the application groups G5 and G6, the application information does not change, and thus, as shown in FIG. 19, the group members do not change.

Next, through the steps S512 to S516, the group state information of the device group G1 is read. However, the added, deleted, or changed devices 100 do not exist in the device group G1, and thus the group operations are not performed. For the device groups G2 and G3, the same process is performed.

Next, through the steps S526, S514 and S520, the group state information of the application group G4 is read. Further, based on the read group state information, the deleted application S2 from the application group G4 is detected. Next, through the step S522, the device group corresponding to the application group G4 is retrieved. According to the group related information registration table 460 of FIG. 6, the device group G1 satisfies the condition, and thus the device group G1 is retrieved. Then, to the device group G1, the devices D1, D2 and D3 belong, and thus the group operations relating to the application S2 are performed on the devices D1, D2 and D3. Therefore, similarly, the application S2 is deleted from the devices D1, D2 and D3.

Next, through the steps S526, S514 and S520, the group state information of the application group G5 is read. However, as regards the application group G5, the added, deleted, or changed application does not exist and thus the group operations are not performed. For the application group G6, the same process is performed.

As such, in the present embodiment, the device management terminal 200 is made to configure the device groups based on the group configuration information and the device information, detect the added, deleted, or changed devices 100 from the configured device groups as the target devices, and perform the group operations to the detected target devices.

Thus, when the number of devices 100 increases or decreases or when the attributes of the devices 100 or the like change, the device information of the device information registration table 400 may be registered, deleted or changed or the group configuration information of the group configuration information registration table 440 may be registered, deleted or changed, such that the configurations of the groups may change. Accordingly, the group operations are performed on the added, deleted, or changed devices among the plurality of devices 100. Therefore, by changing the device information and the group configuration information, the group operations can be performed on the target devices. As a result, as compared to the conventional art, the application management of the devices 100 can be performed relatively easily.

In addition, in the present embodiment, the device management terminal 200 is made to specify the application groups corresponding to the device groups, to which the target devices belong, based on the group related information and perform the group operations relating to the applications, which belong to the specified application groups, to the target devices.

Thus, by defining the correspondence relationship between the device groups and the application groups, the contents of the group operations to the devices 100 can be set. Therefore, the application management of the devices 100 can be further easily performed.

In addition, in the present embodiment, the device management terminal 200 is made to configure the application groups based on the group configuration information and the application information, detect the added, deleted, or changed applications from the configured application groups as the target applications, and perform the group operations relating to the detected target applications to the devices 100.

Thus, when the number of applications increases or decreases or when the attributes of the applications or the like change, the application information of the application information registration table 420 may be registered, deleted or changed or the group configuration information of the group configuration information registration table 440 may be registered, deleted or changed, such that the configurations of the groups may change. Accordingly, the group operations relating to the added, deleted, or changed applications among the plurality of applications are performed on the devices. Therefore, by changing the application information or the group configuration information, the group operations relating to the target applications can be performed on the devices 100. As a result, the application management of the devices 100 can be further easily performed.

In addition, in the present embodiment, the device management terminal 200 is made to specify the device groups corresponding to the application groups, to which the target applications belong, based on the group related information and perform the group operations relating to the target applications to the devices 100 which belong to the specified device groups.

Thus, by defining the correspondence relationship between the device groups and the application groups, the contents of the group operations to the devices 100 can be set. Therefore, the application management of the devices 100 can be further easily performed.

In addition, in the present embodiment, the application distribution terminal 300 is made to distribute the applications in the application storing unit 20 to the target devices, to which the applications are to be added or of which applications are to be changed.

Thus, when the devices 100 are to be newly managed by the system or when the attributes or the like of the devices 100 change, suitable applications can be distributed to the devices 100. Therefore, the distribution of the application can be performed suitably.

In addition, in the present embodiment, the application distribution terminal 300 transmits the application deletion command to the target devices, of which applications are to be deleted or changed.

Thus, when the devices 100 are not to be managed by the system or when the attributes or the like of the devices change, suitable application deletion commands can be received by the device 100. Therefore, the deletion of the application can be performed suitably.

In addition, in the present embodiment, the device management terminal 200 is made to perform the group operations to the target devices at the predetermined period.

Thus, when the number of devices 100 frequently increases or decreases or when the attributes or the like of the devices 100 frequently change, the burden of the system can be prevented from drastically increasing.

In addition, in the present embodiment, the device management terminal 200 is made to perform the group operations relating to the target applications at the predetermined period.

Thus, when the number of applications frequently increases or decreases or when the attributes or the like of the applications change frequently, the burden of the system can be prevented from drastically increasing.

In the above-mentioned embodiment, the device information storing unit 10 corresponds to the device information storing unit of the first, third, nineteenth, twenty-first, thirty-fifth, thirty-seventh, thirty-ninth or forty-first aspect, and the application information storing unit 11 corresponds to the service information storing unit of the second, twentieth, thirty-sixth or fortieth aspect or the application information storing unit of the fourth, sixteenth, twenty-second, thirty-fourth, thirty-eighth, forty-second or fifty-fourth aspect. Further, the group configuration information storing unit 12 corresponds to the group configuration information storing unit of the first to fourth, sixteenth, nineteenth to twenty-second, thirty-fourth to forty-second or fifty-fourth aspect, and the group related information storing unit 13 corresponds to the group related information storing unit of the fourth, fifth, twenty-second, twenty-third, forty-second or forty-third aspect.

Further, in the above-mentioned embodiment, the device group configuration unit 15 and the step S506 correspond to the device group configuration unit of the first or third aspect, the step S506 corresponds to the device group configuration step of the nineteenth, twenty-first, thirty-fifth, thirty-seventh, thirty-ninth or forty-first aspect, and the target device detecting unit 16 and the step S516 correspond to the target device detecting unit of the first, third or tenth aspect. Further, the step S506 corresponds to the target device detection step of the nineteenth, twenty-first, twenty-eighth, thirty-fifth, thirty-seventh, thirty-ninth, forty-first or forty-eighth aspect, and the application group configuration unit 17 and the step S508 correspond to the service group configuration unit of the second aspect or the application group configuration unit of the fourth, fifth or sixteenth aspect.

Further, in the above-mentioned embodiment, the step S508 corresponds to the service group configuration step of the twentieth, thirty-sixth or fortieth aspect or the application group configuration step of the twenty-second, twenty-third, thirty-fourth, thirty-eighth, forty-second, forty-third or the fifty-fourth aspect, and the target application detecting unit 18 and the step S520 correspond to the target service detecting unit of the second aspect, or the target application detecting unit of the fifth, fourteenth or sixteenth aspect. Further, the step S520 corresponds to the target service detection step of the twentieth, thirty-sixth or fortieth aspect, or the target application detection step of the twenty-third, thirty-second, thirty-fourth, thirty-eighth, forty-third, fifty-second or fifty-fourth aspect, and the group operation executing unit 19 and the steps S518 and S522 correspond to the service providing unit of the first or second aspect, or the group operation executing unit the third to fifth, tenth, fourteenth or sixteenth aspect.

Further, in the above-mentioned embodiment, the steps S518 and S522 correspond to the service providing system of the nineteenth, twentieth, thirty-fifth, thirty-sixth, thirty-ninth or fortieth aspect, or the group operation execution step of the twenty-first to twenty-third, twenty-eighth, thirty-second, thirty-fourth, thirty-seventh, thirty-eighth, forty-first to forty-third, forty-eighth, fifty-second or fifty-fourth aspect. Further, the application information corresponds to the service information of the second, twentieth, thirty-sixth or fortieth aspect, the application group corresponds to the service group of the second, twentieth, thirty-sixth or fortieth aspect, and the target application corresponds to the target service of the second, twentieth, thirty-sixth or fortieth aspect.

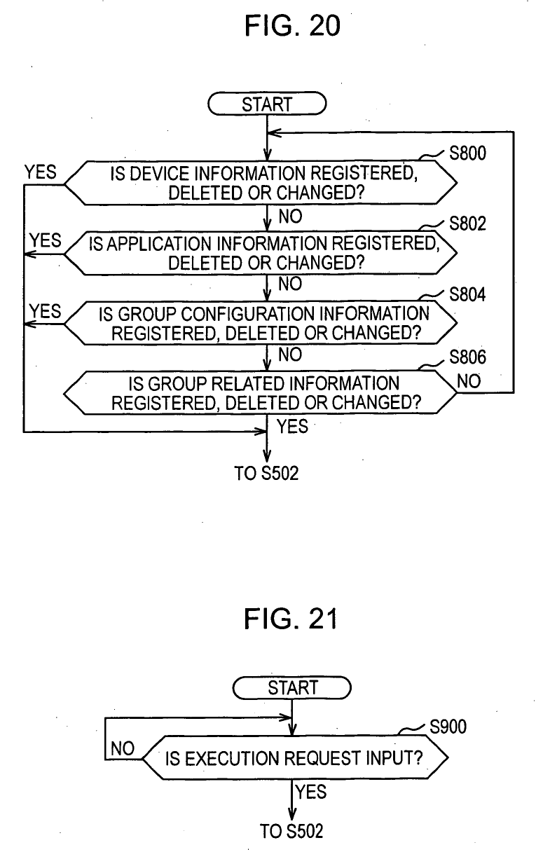

Moreover, in the above-mentioned embodiment, the device management terminal 200 is made to perform the group operations to the target devices and the group operations relating to the target applications at the predetermined period. However, the present invention is not limited to the above-mentioned embodiment. For example, the device management terminal 200 may be made such that the group operations are performed at the time that the device information or the like is registered, deleted or changed. Specifically, the process of the step S500 may be substituted with the process shown in a flowchart of FIG. 20.

FIG. 20 is a flowchart of a group operation execution start process.

The group operation execution start process is a process which determines the group operation execution timing. If the group operation execution start process is executed by the CPU 50, first, the process progresses to the step the S800 as shown in FIG. 20.

In the step S800, it is determined whether or not the device information of the device information registration table 400 is registered, deleted or changed. If it is determined that the device information is registered, deleted or changed (Yes), the process progresses to the step S502.

Meanwhile, in the step S800, if it is determined that the device information is not registered, deleted or changed (No), the process progresses to the step S802. In the step S802, it is determined whether or not the application information of the application information registration table 420 is registered, deleted or changed. If it is determined that the application information is registered, deleted or changed (Yes), the process progresses to the step S502.

Meanwhile, in the step S802, if it is determined that the application information is not registered, deleted or changed (No), the process progresses to the step S804. In the step S804, it is determined whether or not the group configuration information of the group configuration information registration table 440 is register, deleted or changed. If it is determined that the group configuration information is registered, deleted or changed (Yes), the process progresses to the step S502.

Meanwhile, in the step S804, if it is determined that the group configuration information is registered, deleted or changed (No), the process progresses to the step S806. In the step S806, it is determined whether or not the group related information of the group related information registration table 460 is registered, deleted or changed. If it is determined that the group related information is registered, deleted or changed (Yes), the process progresses to the step S502.

Meanwhile, in the step S806, if it is determined that the group related information is not registered, deleted or changed (No), the process progresses to the step S800.

Thus, when the device information of the device information registration table 400 is registered, deleted or changed, or when the group configuration information of the group configuration information registration table 440 changes, the distribution or deletion of the application can be performed on the devices 100, of which application is to be changed, almost in real time. Therefore, the immediate reactivity of the system can be improved. Further, when the application information of the application information registration table 420 is registered, deleted or changed, or when the group configuration information of the group configuration information registration table 440 changes, the distribution or deletion of the application relating the change or the like can be performed almost in real time. Therefore, the immediate reactivity of the system can be improved.

In this case, the device information storing unit 10 corresponds to the device information storing unit of the eighth, twenty-sixth or forty-sixth aspect, the application information storing unit 11 corresponds to the application information storing unit of the twelfth, thirtieth or fiftieth aspect, and the group configuration information storing unit 12 corresponds to the group configuration information storing unit of the ninth, thirteenth, twenty-seventh, thirty-first, forty-seventh or fifty-first aspect. Further, the target device detecting unit 16 and the step S516 correspond to the target device detecting unit of the eighth or ninth aspect, the step S516 corresponds to the target device detection step of the twenty-sixth, twenty-seventh, forty-sixth or forty-seventh aspect, and the target application detecting unit 18 and the step S520 correspond to the target application detecting unit of the twelfth or thirteenth aspect.

Further, the step S520 corresponds to the target application detection step of the thirtieth, thirty-first, fiftieth or fifty-first aspect, and the group operation executing unit 19 and the steps S518 and S522 correspond to the group operation executing unit of the eighth, ninth, twelfth or thirteenth aspect. Further, the steps S518 and S522 correspond to the group operation execution step of the twenty-sixth, twenty-seventh, thirtieth, thirty-first, forty-sixth, forty-seventh, fiftieth or fifty-first aspect.

Further, in the above-mentioned embodiment, the device management terminal 200 is made to perform the group operations to the target devices and the group operations relating to the target applications at a predetermined timing. However, the present invention is not limited to the above-mentioned embodiment. For example, the device management terminal 200 may be made such that the group operations are performed at the time that the execution request is input from the administrator. Specifically, the process of the step S500 may be substituted with the process shown in a flowchart of FIG. 21.

FIG. 21 is a flowchart showing a group operation execution start process.

The group operation execution start process is a process which determines the group operation execution timing. If the group operation execution start process is executed by the CPU 50, first, the process progresses to the step the S900 as shown in FIG. 21.

In the step S900, it is determined whether or not the execution request is input from the administrator. If it is determined that the execution request is input (Yes), the process progresses to the step S502. However, if it is determined that the execution request is not input (No), the process waits in the step S900 until the execution request is input.

Thus, the distribution or deletion of the application can be performed by the administrator's intention. Therefore, the administrator can easily understand and the application management of the devices 100 can be further easily performed.

In this case, the target device detecting unit 16 and the step S516 correspond to the target device detecting unit of the eleventh aspect, the step S516 corresponds to the target device detection step of the twenty-ninth or the forty-ninth aspect, and the target application detecting unit 18 and the step S520 correspond to the target application detecting unit of the fifteenth aspect. Further, the step S520 corresponds to the target application detection step of the thirty-third or fifty-third aspect, the group operation executing unit 19 and the steps S518 and S522 correspond to the group operation executing unit of the eleventh or fifteenth aspect, and the steps S518 and S522 correspond to the group operation execution step of the twenty-ninth, thirty-third, forty-ninth or fifty-third aspect.

Further, in the above-mentioned embodiment, the device management terminal 200 is made to perform the group operations to the target devices and the group operations relating to the target applications at the predetermined period. However, the present invention is not limited to the above-mentioned embodiment. For example, the device management terminal 200 may be made such that one of both group operations is performed at the predetermined timing (for example, the predetermined period or the timing of the registration, deletion, or change of the information) and the other is performed at a different timing.

Further, in the above-mentioned embodiment, the device management terminal 200 and the application distribution terminal 300 are made separately from each other. However, the present invention is not limited to the above-mentioned embodiment. For example, the device management terminal 200 and the application distribution terminal 300 may be integrated as one body.

In this case, the application storing unit 20 corresponds to the application storing unit of the sixth, twenty-fourth or forty-fourth aspect, and the group operation executing unit 19 and the application distribution unit 21 correspond to the group operation executing unit of the sixth or seventh aspect.

Further, in the above-mentioned embodiment, the device management terminal 200 is made to group the devices 100 and the applications and perform the group operations by associating the application groups with the device groups. However, the present invention is not limited to the above-mentioned embodiment. For example, the device management terminal 200 may be made such that the group operations are performed by associating specified applications with the device groups, without grouping the applications. Further, the device management terminal 20 may be made such that the group operations are performed by associating specified devices 100 with the application groups, without grouping the devices 100.

Further, in the above-mentioned embodiment, the device management terminal 200 is made to dynamically configure the device groups and the application groups based on the group configuration information. However, the present invention is not limited to the above-mentioned embodiment. For example, the device management terminal 200 may be made to statically configure the device groups (by respectively specifying the devices 100 belonging to the device groups) and to dynamically configure the application groups based on the group configuration information. Further, the device management terminal 200 may be made to statically configure the application groups (by respectively specifying the applications belonging to the application groups) and to dynamically configure the device groups based on the group configuration information.

Further, according to the above-mentioned embodiment, in the device management terminal 200, when the registration, deletion, or change of the device information and the application information are performed simultaneously, the same application is likely to be distributed to the same device 100 several times. Thus, the transmission history of the application is preferably stored such that the same application is distributed to the same device 100 just once. When the application deletion command is transmitted, the same can be applied.

Further, in the above-mentioned embodiment, the application distribution terminal 300 is made to distribute the applications to the devices 100 according to the application distribution request from the device management terminal 200. However, the present invention is not limited to the above-mentioned embodiment. For example, the application distribution terminal 300 may be made to receive the application distribution list and then to distribute the applications to the devices 100 according to an application confirmation request from the devices 100. When the application deletion command is transmitted, the same can be applied.

Further, in the above-mentioned embodiment, the device information storing unit 10, the application information storing unit 11, the group configuration information storing unit 12, the group related information storing unit 13 are provided in the device management terminal 200. However, the present invention is not limited to the above-mentioned embodiment. For example, the storing units 10 to 13 may be made without providing the device management terminal 200. Specifically, at least the following configuration can be suggested.

The device management terminal 200 may be communicably connected to a database server.

The database server has the device information storing unit 10, the application information storing unit 11, the group configuration information storing unit 12, and the group related information storing unit 13 and provides the device management terminal 200 with the device information, the application information, the group configuration information, and the group related information, according to an acquisition request from the device management terminal 200.

The device management terminal 200 has the device group configuration unit 15, the target device detecting unit 16, the application group configuration unit 17, the target application detecting unit 18, and the group operation executing unit 19.

The device group configuration unit 15 acquires the group configuration information and the device information from the database server, configures the device groups based on the acquired group configuration information and device information, and registers the group state information indicating the state of each of the configured device groups in the group state information storing unit 14.

The application group configuration unit 17 acquires the group configuration information and the application information from the database server, configures the application groups based on the acquired group configuration information and application information, and registers the group state information indicating the state of each of the configured application groups in the group state information storing unit 14.

The group operation executing unit 19 acquires the group related information from the database server, specifies the application groups corresponding to the device groups to which the target devices belong, based on the acquired group related information, and performs the group operations relating to the applications, which belong to the specified application groups, to the target devices. Further, the group operation executing unit 19 acquires the group related information from the database server, specifies the device groups corresponding to the application groups, to which the target applications belong, based on the acquired group related information, and performs the group operations relating to the target applications to the devices 100 which belong to the specified device groups.

Further, in the above-mentioned embodiment, the name, the owner, and the model number of the device 100 are adopted as the device information. However, the present invention is not limited to the above-mentioned embodiment. For example, the manufacturer, the manufacture serial number, the type, the manufacture location and the sales location of the device 100 may be additionally adopted as the device information.

Further, in the above-mentioned embodiment, the name and the provider of the application are adopted as the application information. However, the present invention is not limited to the above-mentioned embodiment. For example, the manufacturer, the manufacture serial number, the type, the manufacture location and the sales location of the application may be additionally adopted as the application information.

Further, in the above-mentioned embodiment, ‘BEGIN WITH . . . ’, ‘ACCORD WITH . . . ’, and the term are adopted as the group configuration condition, but the present invention is not limited to the above-mentioned embodiment. For example, ‘DO NOT ACCORD WITH . . . ’ (≠) ‘LARGER THAN . . . ’ (>), ‘EQUAL TO OR MORE THAN . . . ’ (≧), ‘SMALLER THAN . . . ’ (<), ‘EQUAL TO OR LESS THAN . . . ’ (≦), ‘DO NOT BEGIN WITH . . . ’, ‘END WITH . . . ’, ‘DO NOT END WITH . . . ’, ‘INCLUDE . . . ’, and ‘DO NOT INCLUDE . . . ’ may be additionally adopted as the group configuration condition.

Further, in the above-mentioned embodiment, the type of the device 100 is not specifically described. However, as the device 100, for example, printers, projectors, scanners, digital cameras, digital video cameras, personal computers, PDAs (personal digital assistants), network storages, audio equipments, cellular phones, PHSs (Registered Trademark) (personal handyphone system), watch-type PDAs, STBs (set top box), POS (point of sale) terminals, copy machines, facsimile machines, telephones (including IP telephones and so on), exchangers, NCUs (network control units), routers, hubs, bridges, and other devices may be used.

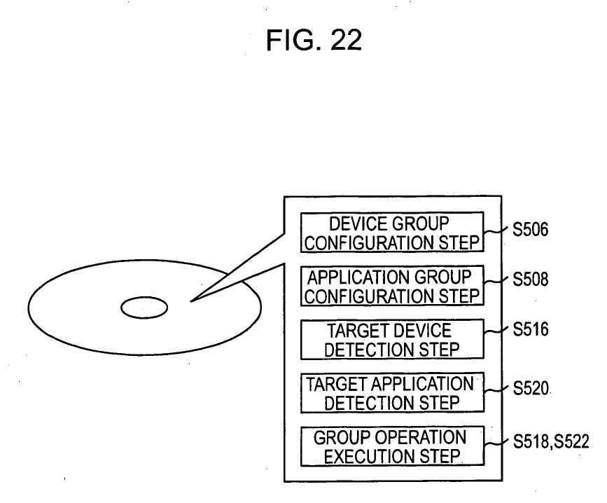

Further, in the above-mentioned embodiment, the case in which the control program is previously stored in the ROM 52 and 72 so as to execute the processes showing in the flowcharts of FIGS. 8 to 12, 14, 15 and 20 is described. However, the present invention is not limited to the above-mentioned embodiment. For example, as shown in FIG. 22, programs may be sequentially stored in a recording medium and, for the execution, may be read from the recording medium to the RAM 54 and 74.

FIG. 22 is a diagram showing a recording medium and its data structure.

Here, as the recording medium, a semiconductor recording medium such as RAM or ROM, a magnetic recordable type recording medium such as FD or HD, an optical readable type recording medium such as CD, CDV, LD or DVD, or a magnetic recordable/optical readable type recording medium such as MO may be used. Specifically, any recording medium may be used as long as it is a computer readable recording medium, irregardless of reading methods such as electronic, magnetic or optical method.

Further, in the above-mentioned embodiment, the case in which the service providing system, the application management system, the service providing apparatus, the service providing program, the application management program, the recording medium, the service providing method, and the application management method according to the present invention are applied to the network system comprising the Internet 199 is described. However, the present invention is not limited to the above-mentioned embodiment. For example, the present invention may be applied to an intranet which performs communications in the same manner as that of the Internet 199. It is needless to say that the present invention is not limited to the network which performs communications in the same manner as that of the Internet 199, but it may be applied to a general network.

Further, in the above-mentioned embodiment, the case in which the service providing system, the application management system, the service providing apparatus, the service providing program, the application management program, the recording medium, the service providing method, and the application management method according to the present invention are applied to the application management of the device 100 as shown in FIG. 1 is described. However, the present invention is not limited to the above-mentioned embodiment, but it may be applied other cases without departing from the scope of the present invention.

1. A service providing system in which a plurality of devices are communicably connected to each other and which provides a service to at least one device of the plurality of communicably connected devices, the service providing system comprising:
a device information storing unit for storing device information which indicates attributes of the communicably connected devices;
a group configuration information storing unit for storing group configuration information which includes conditions of devices constituting device groups;
a device group configuration unit for configuring the device groups based on the group configuration information in the group configuration information storing unit and the device information in the device information storing unit;
a target device detecting unit for detecting at least one of added, deleted, and changed devices from the device groups configured by the device group configuration unit as target devices; and
a service providing unit for providing the service to the target devices detected by the target device detecting unit.

2. A service providing system in which devices are communicably connected to each other and which provides any one of a plurality of services to the communicably connected devices, the service providing system comprising:
a service information storing unit for storing service information which indicates attributes of the services for every service;
a group configuration information storing unit for storing group configuration information which includes conditions of services constituting service groups;
a service group configuration unit for configuring the service groups based on the group configuration information in the group configuration information storing unit and the service information in the service information storing unit;
a target service detecting unit for detecting at least one of added, deleted, and changed services from the service groups configured by the service group configuration unit as target services; and
a service providing unit for providing the target services detected by the target service detecting unit to the devices.

3. An application management system in which a plurality of devices are communicably connected to each other and which manages applications of the plurality of communicably connected devices, the application management system comprising:
a device information storing unit for storing device information which indicates attributes of the communicably connected devices;
a group configuration information storing unit for storing group configuration information which includes conditions of devices constituting device groups;
a device group configuration unit for configuring the device groups based on the group configuration information in the group configuration information storing unit and the device information in the device information storing unit;
a target device detecting unit for detecting at least one of added, deleted, and changed devices from the device groups configured by the device group configuration unit as target devices; and
a group operation executing unit for performing group operations regarding distribution or deletion of the applications on the target devices detected by the target service detecting unit.

4. The application management system according to claim 3,
wherein the group configuration information includes conditions of applications constituting application groups,
wherein the application management system further comprises:
an application information storing unit for storing application information which indicates attributes of the applications for every application;
an application group configuration unit for configuring the application groups based on the group configuration information in the group configuration information storing unit and the application information in the application information storing unit; and
a group related information storing unit for storing group related information which indicates a correspondence relationship between the device groups and the application groups, and
wherein the group operation executing unit specifies the application groups corresponding to the device groups to which the target devices belong, based on the group related information in the group related information storing unit, and performs the group operations relating to the applications, which belong to the specified application groups, on the target devices.

5. The application management system according to claim 4, further comprising:
a target application detecting unit for detecting at least one of added, deleted, and changed applications from the application groups configured by the application group configuration unit as target applications,
wherein the group operation executing unit specifies the device groups corresponding to the application groups to which the target applications detected by the target application detecting unit belong, based on the group related information in the group related information storing unit, and performs the group operations relating to the target applications on the devices which belong to the specified device groups.

6. The application management system according to claim 3, further comprising:
an application storing unit for storing applications,
wherein the group operation executing unit distributes the applications in the application storing unit to the target devices to which the applications are to be added or of which applications are to be changed.

7. The application management system according to claim 3,
wherein the group operation executing unit transmits an application deletion command to the target devices of which applications are to be deleted or changed.

8. The application management system according to claim 3,
wherein the detection by the target device detecting unit and the execution by the group operation executing unit are performed when a registration, deletion, or change of the device information is performed on the device information storing unit.

9. The application management system according to claim 3,
wherein the detection by the target device detecting unit and the execution by the group operation executing unit are performed when a change of the group configuration information is performed on the group configuration information storing unit.

10. The application management system according to claim 3,
wherein the detection by the target device detecting unit and the execution by the group operation executing unit are performed at predetermined intervals.

11. The application management system according to claim 3,
wherein the detection by the target device detecting unit and the execution by the group operation executing unit are performed when an execution request is input.

12. The application management system according to claim 5,
wherein the detection by the target application detecting unit and the execution by the group operation executing unit are performed when the registration, deletion, or change of the application information is performed on the application information storing unit.

13. The application management system according to claim 5,
wherein the detection by the target application detecting unit and the execution by the group operation executing unit are performed when the change of the group configuration information is performed on the group configuration information storing unit.

14. The application management system according to claim 5,
wherein the detection by the target application detecting unit and the execution by the group operation executing unit are performed at predetermined intervals.

15. The application management system according to claim 5,
wherein the detection by the target application detecting unit and the execution by the group operation executing unit are performed when an execution request is input.

16. An application management system in which devices are communicably connected to each other and which manages applications of the communicably connected devices, the application management system comprising:
an application information storing unit for storing application information which indicates attributes of the applications for every application;
a group configuration information storing unit for storing group configuration information which includes conditions of applications constituting application groups;
an application group configuration unit for configuring the application groups based on the group configuration information in the group configuration information storing unit and the application information in the application information storing unit;
a target application detecting unit for detecting at least one of added, deleted, and changed applications from the application groups configured by the application group configuration unit as target applications; and
a group operation executing unit for performing group operations regarding distribution or deletion of the target applications detected by the target application detecting unit on the devices.

17. A service providing apparatus in which a plurality of devices are communicably connected to each other and which provides a service to at least one device of the plurality of communicably connected devices, the service providing apparatus comprising:
a device group configuration unit for acquiring from a database device, which has a device information storing unit for storing device information which indicates attributes of the communicably connected devices and a group configuration information storing unit for storing group configuration information which includes conditions of devices constituting device groups, the group configuration information and the device information and for configuring the device groups based on the acquired group configuration information and device information;
a target device detecting unit for detecting at least one of added, deleted, and changed devices from the device groups configured by the device group configuration unit as target devices; and
a service providing unit for providing the service to the target devices detected by the target device detecting unit.

18. A service providing apparatus in which devices are communicably connected to each other and which provides any one of a plurality of services to the communicably connected devices, the service providing apparatus comprising:
a service group configuration unit for acquiring from a database device, which has a service information storing unit for storing service information which indicates attributes of the services for every service and a group configuration information storing unit for storing group configuration information which includes conditions of services constituting service groups, the group configuration information and the service information, and for configuring the service groups based on the acquired group configuration information and the service information;
a target service detecting unit for detecting at least one of added, deleted, and changed services from the service groups configured by the service group configuration unit as target services; and
a service providing unit for providing the target services detected by the target service detecting unit to the devices.

19. A service providing program which provides a service to devices and which causes a computer, which uses a device information storing unit for storing device information which indicates attributes of the communicably connected devices and a group configuration information storing unit for storing group configuration information which includes conditions of devices constituting device groups, to execute a process comprising the method of claim 27.

20. A service providing program which provides services to devices and which causes a computer, which uses a service information storing unit for storing service information which indicates attributes of the services for every service and a group configuration information storing unit for storing group configuration information which includes conditions of services constituting service groups, to execute a process comprising the method of claim 28.

21. An application management program which manages applications of devices and which causes a computer, which uses a device information storing unit for storing device information which indicates attributes of the communicably connected devices and a group configuration information storing unit for storing group configuration information which includes conditions of devices constituting device groups, to execute a process comprising the method of claim 29.

22. An application management program which manages applications of devices and which causes a computer, which uses an application information storing unit for storing application information which indicates attributes of the applications for every application and a group configuration information storing unit for storing group configuration information which includes conditions of applications constituting application groups, to execute a process comprising the method of claim 30.

23. A recording medium on which a service providing program for providing a service to devices is recorded,
wherein the service providing program comprises the service providing program of claim 19.

24. A recording medium on which a service providing program for providing services to devices is recorded,
wherein the service providing program comprises the service providing program of claim 20.

25. A recording medium on which an application management program for managing applications of devices is recorded,
wherein the application management program comprises the application management program of claim 21.

26. A recording medium on which an application management program for managing applications of devices is recorded,
wherein the application management program comprises the application management program of claim 22.

27. A service providing method in which a plurality of devices are communicably connected to each other and which provide a service to at least one device of the plurality of communicably connected devices, the service providing method comprising:
a device group configuration step of configuring device groups based on group configuration information, which includes device conditions of the device groups, stored in a group configuration information storing unit and device information, which indicates attributes of the communicably connected devices, stored in a device information storing unit;
a target device detection step of detecting at least one of added, deleted, and changed devices from the device groups configured in the device group configuration step as target devices; and
a service provision step of providing the service to the target devices detected in the target device detection step.

28. A service providing method in which devices are communicably connected to each other and which provides any one of a plurality of services to the communicably connected devices, the service providing method comprising:
a service group configuration step of configuring service groups based on group configuration information, which includes service conditions of the service groups, stored in a group configuration information storing unit and service information, which indicates attributes of the services for every service, stored in a device information storing unit;
a target service detection step of detecting at least one of added, deleted, and changed services from the service groups configured in the service group configuration step as target services; and
a service provision step of providing the target services detected in the target service detection step to the devices.

29. An application management method in which a plurality of devices are communicably connected to each other and which manages applications of the plurality of communicably connected devices, the application management method comprising:
a device group configuration step of configuring device groups based on group configuration information, which includes device conditions of the device groups, stored in a group configuration information storing unit and device information, which indicates attributes of the communicably connected devices, stored in a device information storing unit;
a target device detection step of detecting at least one of added, deleted, and changed devices from the device groups configured in the device group configuration step as target devices; and
a group operation execution step of performing group operations regarding distribution or deletion of the applications on the target devices detected in the target device detection step.

30. An application management method in which devices are communicably connected to each other and which manages applications of the communicably connected devices, the application management method comprising:
an application group configuration step of configuring application groups based on group configuration information, which includes conditions of applications of the application groups, stored in a group configuration information storing unit and application information, which indicates attributes of the application for every application, stored in an application information storing unit;
a target application detection step of detecting at least one of added, deleted, and changed applications from the application groups configured in the application group configuration step as target applications; and
a group operation execution step of performing group operations regarding distribution or deletion of the target applications detected in the target application detection step, on the devices.
